(19) United States
(12) Patent Application Publication
(10) Pub. No.: US 2017/0237182 A1
(43) Pub. Date: Aug. 17, 2017

(54) ANTENNA WITH BEAMWIDTH RECONFIGURABLE CIRCULARLY POLARIZED RADIATORS

(71) Applicant: QUALCOMM Incorporated, San Diego, CA (US)

(72) Inventor: Allen Minh-Triet TRAN, San Diego, CA (US)

(21) Appl. No.: 15/269,800

(22) Filed: Sep. 19, 2016

Related U.S. Application Data
(60) Provisional application No. 62/221,245, filed on Sep. 21, 2015.

(51) Int. Cl. H01Q 21/24; H01Q 21/00; H01Q 1/28; H01Q 1/12

(52) U.S. Cl. CPC H01Q 21/245; H01Q 1/1214; H01Q 21/24; H01Q 21/0031; H01Q 1/288

(57) ABSTRACT

An antenna is provided for a satellite in a satellite communication system. The antenna includes an array of radiators each having a dual linear-to-circular polarizer. The array of radiators is aligned in a first plane and configured to generate an elliptical beam having a desired narrow beamwidth in the first plane. Conductive walls provided around an aperture of each radiator in the array of radiators may narrow a wider beamwidth of the elliptical beam in a second plane orthogonal to the first plane to a desired value.

### CROSS-REFERENCE TO RELATED APPLICATIONS

The present application for Patent claims the benefit of U.S. Provisional Application No. 62/221,245, entitled “ANTENNA WITH BEAMWIDTH RECONFIGURABLE CIRCULARLY POLARIZED RADIATORS,” filed Sep. 21, 2015, and assigned to the assignee hereof, and expressly incorporated herein by reference in its entirety.

### INTRODUCTION

Various aspects described herein relate to satellite communications, and more particularly, to satellite antennas.

Conventional satellite-based communication systems include gateways and one or more satellites to relay communication signals between the gateways and one or more user terminals. A gateway is an Earth station having an antenna for transmitting signals to, and receiving signals from, communication satellites. A gateway provides communication links, using satellites, for connecting a user terminal to other user terminals or users of other communication systems, such as a public switched telephone network, the Internet and various public and/or private networks. A satellite is an orbiting receiver and repeater used to relay information.

A satellite can receive signals from and transmit signals to a user terminal provided the user terminal is within the “footprint” of the satellite. The footprint of a satellite is the geographic region on the surface of the Earth within the range of signals of the satellite. The footprint is usually geographically divided into “beams,” through the use of beam-forming antennas. Each beam covers a particular geographic region within the footprint. Beams may be directed such that more than one beam from the same satellite may cover a given geographic region.

Geosynchronous satellites have long been used for communications. A geosynchronous satellite is stationary relative to a given location on the Earth, and thus, there is little timing shift and Doppler frequency shift in radio signal propagation between a communication transceiver on the Earth and the geosynchronous satellite. However, because geosynchronous satellites are limited to a geosynchronous orbit (GSO), which is a circle having a radius of approximately 42,164 km from the center of the Earth directly above the Earth's equator, the number of satellites that may be placed in the GSO is limited. As alternatives to geosynchronous satellites, communication systems that utilize a constellation of satellites in non-geosynchronous orbits, such as low-earth orbits (LEO), have been devised to provide communication coverage to the entire Earth or at least large parts of the Earth.

Each satellite in a satellite communication system may be required to communicate with one or more ground stations, including one or more user terminals (UTs) and/or one or more gateways. Each satellite may include one or more antennas that transmit signals to, and receive signals from, ground stations. Moreover, each antenna may be required to scan over a wide range of azimuth angles to provide communication coverage over a large surface area of the Earth.

It is desirable that the components of a satellite, including the antenna, have as little mass and occupy as little volume as possible in order to reduce the launch cost of the satellite. Moreover, it is desirable to provide a low-loss, high-efficiency antenna in the satellite to reduce the amount of transmit power required for the power amplifier (PA), thereby allowing the mass, size and cost of the PA to be reduced.

A communication satellite may be required to communicate with various ground stations, which may be disposed at different locations and therefore have antennas arranged at different orientations with respect to the antenna at the communication satellite. If the beams on forward and/or return links within the footprint of the communication satellite are linearly polarized, then the polarization of the receive antenna needs to be aligned with the polarization of the transmit antenna. Otherwise, signal reception may be attenuated. In the worst case scenario, if the polarizations of the transmit and receive antennas are oriented at 90° with respect to each other, then a signal transmitted from the transmit antenna may not be received at the receive antenna. Therefore, circularly polarized antennas are used in satellite communication systems to obviate the need to align the directions of polarizations of transmit and receive antennas with respect to each other in case of linear polarization. For example, if signals transmitted from the satellite to the ground station are right-hand circularly polarized (RHCP), then signals transmitted from the ground station to the satellite are left-hand circularly polarized (LHCP), or vice versa. Issues may arise, however, because certain regulatory interference limits may require a communication satellite to have an antenna beam configuration with different beamwidths in two orthogonal planes, which implies an antenna aperture with a larger physical dimension in one plane and a smaller physical dimension in the orthogonal plane. However, a circularly polarized radiator tends to have either a square or circular aperture shape to produce a circularly polarized signal with an axial ratio close to one (1). Accordingly, there is a need to control the beamwidth associated with a satellite antenna without substantially adding to the weight, cost, size, complexity, etc. associated with the antenna structure.

### SUMMARY

Aspects of the disclosure are directed to antennas for satellites in satellite communication systems.

In an aspect, an antenna may comprise a radio-frequency (RF) transmission network, an array of radiators coupled to the RF transmission network, and a conductive bracket comprising at least a first conductive wall and a second conductive wall disposed along the array of radiators, wherein each radiator may have a first port with a right-handed elliptical polarized radiation pattern and a second port with a left-handed elliptical polarized radiation pattern.

In an aspect, an apparatus may comprise a waveguide network, an array of radiators coupled to the waveguide network, and a conductive bracket, wherein the array of radiators may be aligned along a first direction and have a beam with a first beamwidth in the first direction, each radiator may comprise a linear-to-circular polarizer, and the conductive bracket may be aligned along the first direction to reflect radiation in a second direction orthogonal to the first direction.

In an aspect, an apparatus may comprise an array of radiators aligned along a first direction and having a beam with a first beamwidth in the first direction, wherein each radiator may comprise means for generating dual circularly polarized signals, and the apparatus may further comprise means for reflecting radiation associated with the dual circularly polarized signals, wherein the means for reflecting radiation may be aligned along the first direction to reflect the radiation in a second direction orthogonal to the first direction.

In an aspect, a method for forming a satellite antenna may comprise forming a linear array of radiators aligned along a first direction, wherein each radiator in the linear array of radiators is configured to generate a beam comprising dual circularly polarized signals having a first beamwidth in the first direction and forming a conductive bracket aligned along the first direction to reflect radiation in a second direction orthogonal to the first direction such that the beam has a second beamwidth in the second direction larger than the first beamwidth in the first direction.

In an aspect, a method for forming an antenna structure may comprise forming a linear array of radiators along a first plane, wherein the linear array of radiators may be configured to generate an elliptical beam having a first beamwidth in the first plane. In an aspect, the method may additionally comprise forming a conductive bracket around each radiator in the linear array of radiators, wherein the conductive bracket may be configured to reflect radiation such that the elliptical beam has a second beamwidth in a second plane orthogonal to the first plane.

In an aspect, a method for configuring an antenna beam footprint may comprise generating, via a linear radiator array, an elliptical beam with a first beamwidth in a first plane and a second beamwidth in a second plane and reflecting radiation by a conductive bracket aligned along the first plane such that the second beamwidth in the second plane is shaped to a desired value.

### BRIEF DESCRIPTION OF THE DRAWINGS

The accompanying drawings are presented to aid in the description of aspects of the disclosure and are provided solely for illustration of the aspects and not limitations thereof.

FIG. 1 is a block diagram of an example of a communication system.

FIG. 2 is a block diagram of an example of the gateway of FIG. 1.

FIG. 3 is a block diagram of an example of the satellite of FIG. 1.

FIG. 4 is a block diagram of an example of the user terminal of FIG. 1.

FIG. 5 is a block diagram of an example of the user equipment of FIG. 1.

FIG. 6 is a diagram illustrating an example of a communication satellite having an antenna configured to form multiple radio beams scanning within a range of azimuth angles to cover a given surface area of the Earth.

FIG. 7 is a block diagram illustrating an example method to design a satellite antenna that can form an elliptical beam pattern having desired beamwidths in two orthogonal planes.

FIG. 8 illustrates an example elliptical beam pattern having desired beamwidths in two orthogonal planes.

FIG. 9 illustrates example structural elements that can be used to form an antenna that can produce the desired elliptical beam pattern.

FIGS. 10A-10F illustrate example structural elements that can be used to form an antenna that can produce the desired elliptical beam pattern.

FIG. 11 illustrates example structural elements that can be used to form an antenna that can produce the desired elliptical beam pattern.

FIG. 12 is a perspective view of an example of a satellite antenna structure.

FIG. 13 is a perspective view of an example of a dual circular polarization (CP) radiator implemented in the satellite antenna structure of FIG. 12.

FIG. 14 is a perspective view of an example of a dual CP radiator with conductive walls formed around an aperture.

FIG. 15 is a side sectional view of the dual CP radiator of FIG. 14.

FIG. 16 is a perspective view of an alternate example of a dual CP radiator with conductive walls formed around an aperture.

FIG. 17 is a perspective view of an alternate example of a satellite antenna with separate transmit and receive waveguide feeds.

FIG. 18 is a diagram illustrating an example communication satellite having an antenna configured to form a composite beam pattern with elliptical beams that have reconfigurable beamwidths to achieve a desired area or angular coverage.

FIG. 19 illustrates an example satellite apparatus configured to generate an elliptical beam to achieve a desired area or angular coverage.

### DETAILED DESCRIPTION

Various aspects of the disclosure relate to antennas on satellites for bidirectional communications with ground stations in satellite communication systems. In one aspect, an antenna includes an array of radiators, such as open-ended waveguides or horns, or other suitable types of radiator elements. In one aspect, the array of radiators may generate a beam having a relatively narrow beamwidth along one orientation and a relatively wide beamwidth along another orientation. In one aspect, a linear-to-circular polarizer may be provided in each of the radiators to circularly polarize the radio beams. In a further aspect, dual circular polarization (CP) radiators may be implemented to allow the antenna to transmit and receive radio signals of opposite circular polarizations. Furthermore, according to various aspects, the antenna may be configured to form a composite beam pattern with multiple beams that have reconfigurable beamwidths in two orthogonal planes to achieve a desired area or angular coverage. For example, the antenna may comprise multiple arrays of radiators that are each configured to generate a beam with a relatively narrow beamwidth in a first plane and a substantially wider beamwidth in a second plane orthogonal to the first plane. In one aspect, a minimum height for each array of radiators may be determined according to the narrower beamwidth requirement and a desired operating frequency and other parameters associated with each array of radiators may be determined according to various system requirements (e.g., a number of radiators in each array, cell dimensions for the radiators in each respective array, an inter-element spacing between the radiators in each respective array, etc.). To narrow the beamwidth in the second plane and thereby achieve the desired area or angular coverage, conductive walls may be disposed around an aperture associated with radiator, wherein dimensions associated with the conductive walls and locations where the conductive walls are arranged around the aperture associated with each radiator may be configured to narrow the wider beamwidth in the second plane to a desired value. In one aspect, the multiple arrays of radiators may therefore be centered in second plane and each individual radio beam can be electrically or mechanically pointed to a certain angle in the first plane to thereby form the composite beam pattern with the desired beamwidths in the two orthogonal planes. Various other aspects of the disclosure will also be described below in further detail.

Specific examples of the disclosure are described in the following description and related drawings. Alternate examples may be devised without departing from the scope of the disclosure. Additionally, well-known elements will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation.

The terminology used herein is for the purpose of describing particular aspects only and is not intended to be limiting of the aspects. As used herein, the singular forms “a,” “an,” and “the” are intended to include the plural forms as well, unless the context clearly indicates otherwise. It will be further understood that the terms “comprises,” “comprising,” “includes,” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to,” or “in communication with” are not limited to direct connections unless expressly stated otherwise.

Further, many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application-specific integrated circuits (ASICs), field programmable gate arrays (FPGAs), or various other types of general purpose or special purpose processors or circuits, by program instructions being executed by one or more processors, or by a combination of both. Additionally, the sequence of actions described herein can be considered to be embodied entirely within any form of computer-readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

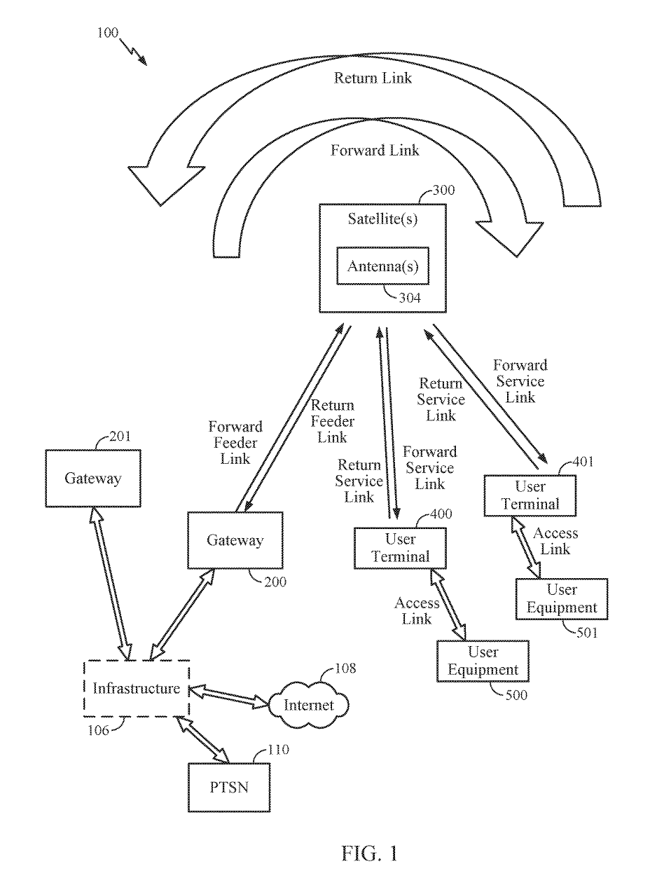

FIG. 1 illustrates an example of a satellite communication system 100 which includes a plurality of satellites (although only one satellite 300 is shown in FIG. 1 for clarity of illustration) in non-geosynchronous orbits, for example, low-earth orbits (LEO). In addition, the satellite communication system 100 may include a gateway 200 in communication with the satellite 300, a plurality of user terminals (UTs) 400 and 401 in communication with the satellite 300, and a plurality of user equipments (UEs) 500 and 501 in communication with the UTs 400 and 401, respectively. Each of the UE 500 or 501 may be a user device such as a mobile device, a telephone, a smartphone, a tablet, a laptop computer, a computer, a wearable device, a smart watch, an audiovisual device, or any device including the capability to communicate with a UT. Additionally, the UE 500 and/or the UE 501 may be a device (e.g., access point, small cell, etc.) used to communicate with one or more end user devices. In the example illustrated in FIG. 1, the UT 400 and the UE 500 communicate with each other via a bidirectional access link having a forward access link and return access link, and the UT 401 and the UE 501 similarly communicate with each other via another bidirectional access link. In another implementation, one or more additional UEs (not shown) may be configured to receive only and therefore only communicate with a UT using a forward access link. In another implementation, one or more additional UEs (not shown) may also communicate with the UT 400 or UT 401. Alternatively, a UT and a corresponding UE may be integral parts of a single physical device, such as a mobile telephone with an integral satellite transceiver and an antenna for communicating directly with a satellite, for example.

The gateway 200 may have access to the Internet 108 or one or more other types of public, semiprivate, or private networks. In the example illustrated in FIG. 1, the gateway 200 is in communication with infrastructure 106, which is capable of accessing the Internet 108 or one or more other types of public, semiprivate, or private networks. The gateway 200 may also be coupled to various types of communication backhaul, including, for example, landline networks such as optical fiber networks or public switched telephone networks (PSTN) 110. Further, in alternative implementations the gateway 200 may interface to the Internet 108, the PSTN 110, or one or more other types of public, semiprivate, or private networks without using the infrastructure 106. Furthermore, the gateway 200 may communicate with other gateways, such as gateway 201 through the infrastructure 106 or alternatively may be configured to communicate with the gateway 201 without using the infrastructure 106. The infrastructure 106 may include, in whole or part, a network control center (NCC), a satellite control center (SCC), a wired and/or wireless core network, and/or any other components or systems used to facilitate operation of and/or communication with the satellite communication system 100.

Communications between the satellite 300 and the gateway 200 in both directions are called feeder links, whereas communications between the satellite 300 and each of the UTs 400 and 401 in both directions are called service links. A signal path from the satellite 300 to a ground station, which may be the gateway 200 or one of the UTs 400 and 401, may generally be called a downlink. A signal path from a ground station to the satellite 300 may generally be called an uplink. Additionally, as illustrated, signals can have a general directionality such as a forward link and a return link or reverse link. Accordingly, a communication link in a direction originating from the gateway 200 and terminating at the UT 400 through the satellite 300 is called a forward link, whereas a communication link in a direction originating from the UT 400 and terminating at the gateway 200 through the satellite 300 is called a return link or reverse link. As such, the signal path from the gateway 200 to the satellite 300 is labeled “Forward Feeder Link” in FIG. 1, whereas the signal path from the satellite 300 to the gateway 200 is labeled “Return Feeder Link” in FIG. 1. In a similar manner, the signal path from each UT 400 or 401 to the satellite 300 is labeled “Return Service Link” in FIG. 1, whereas the signal path from the satellite 300 to each UT 400 or 401 is labeled “Forward Service Link” in FIG. 1.

The satellite 300 may use one or more antennas 304 to communicate with the gateway 200 via the forward and reverse feeder links, with the UTs 400, 401 via the forward and reverse service links, etc. For example, as will be described in further detail below, the one or more antennas 304 may include a linear array of radiators, such as open-ended waveguides or horns, or other suitable types of radiator elements. In one aspect, the linear array of radiators may be stacked or otherwise aligned in a first plane (e.g., a North-South plane) to generate a composite beam pattern in which each beam has a relatively narrow beamwidth in the first plane along which the linear array of radiators is aligned. Furthermore, the linear of array of radiators may have a second beamwidth in a second plane orthogonal to the first plane in which the linear array of radiators is aligned (e.g., an East-West plane). As such, the one or more antennas 304 may produce the composite beam pattern such that each beam in the composite beam pattern has a relatively narrow beamwidth in the first plane and a relatively wider beamwidth in the second plane, wherein the narrow beamwidth in the first plane and the wider beamwidth in the second plane may be reconfigurable to meet different requirements. For example, the reconfigurable beamwidth(s) may advantageously provide an efficient way to meet regulatory interference limits (e.g., limits that the International Telecommunication Union (ITU) provides on the equivalent power flux-density (EPFD) that a non-geosynchronous orbit (NGSO) satellite may produce at any point on the Earth's surface that lies within the footprint of a geosynchronous orbit (GSO) satellite).

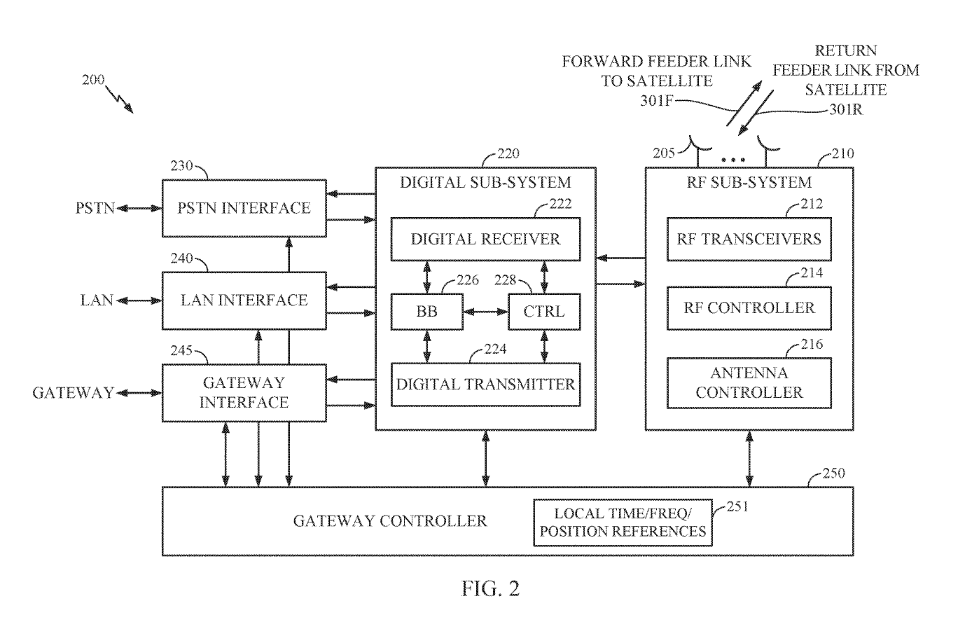

FIG. 2 is an example block diagram of the gateway 200, which also can apply to the gateway 201 of FIG. 1. The gateway 200 is shown to include a number of antennas 205, an RF subsystem 210, a digital subsystem 220, a Public Switched Telephone Network (PSTN) interface 230, a Local Area Network (LAN) interface 240, a gateway interface 245, and a gateway controller 250. The RF subsystem 210 is coupled to the antennas 205 and to the digital subsystem 220. The digital subsystem 220 is coupled to the PSTN interface 230, to the LAN interface 240, and to the gateway interface 245. The gateway controller 250 is coupled to the RF subsystem 210, the digital subsystem 220, the PSTN interface 230, the LAN interface 240, and the gateway interface 245.

The RF subsystem 210, which may include a number of RF transceivers 212, an RF controller 214, and an antenna controller 216, may transmit communication signals to the satellite 300 via a forward feeder link 301F, and may receive communication signals from the satellite 300 via a return feeder link 301R. Although not shown for simplicity, each of the RF transceivers 212 may include a transmit chain and a receive chain. Each receive chain may include a low noise amplifier (LNA) and a down-converter (e.g., a mixer) to amplify and down-convert, respectively, received communication signals in a well-known manner. In addition, each receive chain may include an analog-to-digital converter (ADC) to convert the received communication signals from analog signals to digital signals (e.g., for processing by the digital subsystem 220). Each transmit chain may include an up-converter (e.g., a mixer) and a power amplifier (PA) to up-convert and amplify, respectively, communication signals to be transmitted to the satellite 300 in a well-known manner. In addition, each transmit chain may include a digital-to-analog converter (DAC) to convert the digital signals received from the digital subsystem 220 to analog signals to be transmitted to the satellite 300.

The RF controller 214 may be used to control various aspects of the number of RF transceivers 212 (e.g., selection of the carrier frequency, frequency and phase calibration, gain settings, and the like). The antenna controller 216 may further control various aspects of the antennas 205 (e.g., beamforming, beam steering, gain settings, frequency tuning, and the like).

The digital subsystem 220 may include a number of digital receiver modules 222, a number of digital transmitter modules 224, a baseband (BB) processor 226, and a control (CTRL) processor 228. The digital subsystem 220 may process communication signals received from the RF subsystem 210 and forward the processed communication signals to the PSTN interface 230 and/or the LAN interface 240, and may process communication signals received from the PSTN interface 230 and/or the LAN interface 240 and forward the processed communication signals to the RF subsystem 210.

Each digital receiver module 222 may correspond to signal processing elements used to manage communications between the gateway 200 and the UT 400. One of the receive chains of the RF transceivers 212 may provide input signals to the digital receiver modules 222. A number of the digital receiver modules 222 may be used to accommodate all of the satellite beams and possible diversity mode signals being handled at any given time. Although not shown for simplicity, each digital receiver module 222 may include one or more digital data receivers, a searcher receiver, and a diversity combiner and decoder circuit. The searcher receiver may be used to search for appropriate diversity modes of carrier signals, and may be used to search for pilot signals (or other relatively fixed pattern strong signals).

The digital transmitter modules 224 may process signals to be transmitted to the UT 400 via the satellite 300. Although not shown for simplicity, the digital transmitter modules 224 may each include a transmit modulator that modulates data for transmission. The transmission power of each transmit modulator may be controlled by a corresponding digital transmit power controller (not shown for simplicity) that may (1) apply a minimum level of power for purposes of interference reduction and resource allocation and (2) apply appropriate levels of power when needed to compensate for attenuation in the transmission path and other path transfer characteristics.

The control (CTRL) processor 228, which is coupled to the digital receiver modules 222, the digital transmitter modules 224, and the baseband (BB) processor 226, may provide command and control signals to effect functions such as, but not limited to, signal processing, timing signal generation, power control, handoff control, diversity combining, and system interfacing.

The control (CTRL) processor 228 may also control the generation and power of pilot, synchronization, and paging channel signals and their coupling to the transmit power controller (not shown for simplicity). The pilot channel is a signal that is not modulated by data, and may use a repetitive unchanging pattern or non-varying frame structure type (pattern) or tone type input. For example, the orthogonal function used to form the channel for the pilot signal generally has a constant value, such as all ones (1's) or zeros (0's), or a well-known repetitive pattern, such as a structured pattern of interspersed ones (1's) and zeros (0's).

The baseband (BB) processor 226 is well known in the art and is therefore not described in detail herein. For example, the baseband (BB) processor 226 may include a variety of known elements such as (but not limited to) coders, data modems, and digital data switching and storage components.

The PSTN interface 230 may provide communication signals to, and receive communication signals from, an external PSTN either directly or through the infrastructure 106, as illustrated in FIG. 1. The PSTN interface 230 is well known in the art, and therefore is not described in detail herein. For other implementations, the PSTN interface 230 may be omitted, or may be replaced with any other suitable interface that connects the gateway 200 to a ground-based network (e.g., the Internet).

The LAN interface 240 may provide communication signals to, and receive communication signals from, an external LAN. For example, the LAN interface 240 may be coupled to the Internet 108 either directly or through the infrastructure 106, as illustrated in FIG. 1. The LAN interface 240 is well known in the art, and therefore is not described in detail herein.

The gateway interface 245 may provide communication signals to, and receive communication signals from, one or more other gateways associated with the satellite communication system 100 of FIG. 1 (and/or to/from gateways associated with other satellite communication systems, not shown for simplicity). For some implementations, the gateway interface 245 may communicate with other gateways via one or more dedicated communication lines or channels (not shown for simplicity). For other implementations, the gateway interface 245 may communicate with other gateways using the PSTN interface 230 and/or other networks such as the Internet 108 (see also FIG. 1). For at least one implementation, the gateway interface 245 may communicate with other gateways via the infrastructure 106.

Overall gateway control may be provided by the gateway controller 250. The gateway controller 250 may plan and control utilization of resources associated with the satellite 300 by the gateway 200. For example, the gateway controller 250 may analyze trends, generate traffic plans, allocate satellite resources, monitor (or track) satellite positions, and monitor the performance of the gateway 200 and/or the satellite 300. The gateway controller 250 may also be coupled to a ground-based satellite controller (not shown for simplicity) that maintains and monitors orbits of the satellite 300, relays satellite usage information to the gateway 200, tracks positions of the satellite 300, and/or adjusts various channel settings of the satellite 300.

For the example implementation illustrated in FIG. 2, the gateway controller 250 includes a local time, frequency, and position references 251, which may provide local time or frequency information to the RF subsystem 210, the digital subsystem 220, and/or the interfaces 230, 240, and 245. The time or frequency information may be used to synchronize the various components of the gateway 200 with each other and/or with the satellite 300. The local time, frequency, and position references 251 may also provide position information (e.g., ephemeris data) of the satellite 300 to the various components of the gateway 200. Further, although depicted in FIG. 2 as included within the gateway controller 250, for other implementations, the local time, frequency, and position references 251 may be a separate subsystem that is coupled to the gateway controller 250 (and/or to one or more of the digital subsystem 220 and the RF subsystem 210).

Although not shown in FIG. 2 for simplicity, the gateway controller 250 may also be coupled to a network control center (NCC) and/or a satellite control center (SCC). For example, the gateway controller 250 may allow the SCC to communicate directly with the satellite 300, for example, to retrieve ephemeris data from the satellite 300. The gateway controller 250 may also receive processed information (e.g., from the SCC and/or the NCC) that allows the gateway controller 250 to properly aim the antennas 205 (e.g., at the satellite 300), to schedule beam transmissions, to coordinate handovers, and to perform various other well-known functions.

FIG. 3 is an example block diagram of the satellite 300 for illustrative purposes only. It will be appreciated that specific satellite configurations can vary significantly and may or may not include on-board processing. Further, although illustrated as a single satellite, two or more satellites using inter-satellite communication may provide the functional connection between the gateway 200 and the UT 400. It will be appreciated that the disclosure is not limited to any specific satellite configuration, and any satellite or combinations of satellites that can provide the functional connection between the gateway 200 and the UT 400 can be considered within the scope of the disclosure. In one example, the satellite 300 is shown to include a forward transponder 310, a return transponder 320, an oscillator 330, a controller 340, forward link antennas 352(1)-352(N), and return link antennas 361(1)-361(N). The forward transponder 310, which may process communication signals within a corresponding channel or frequency band, may include a respective one of first bandpass filters 311(1)-311(N), a respective one of first LNAs 312(1)-312(N), a respective one of frequency converters 313(1)-313(N), a respective one of second LNAs 314(1)-314(N), a respective one of second bandpass filters 315(1)-315(N), and a respective one of PAs 316(1)-316(N). Each of the PAs 316(1)-316(N) is coupled to a respective one of the antennas 352(1)-352(N), as shown in FIG. 3. The forward transponder 310 may thus receive communication signals from the gateway 200 along forward feeder link 301F via one or more antennas 351 and transmit communication signals to the UT 400 along forward service link 302F via one or more antennas 352(1)-352(N).

Within each of the respective forward paths FP(1)-FP(N), the first bandpass filters 311(1)-311(N) pass signal components having frequencies within the channel or frequency band of the respective forward paths FP(1)-FP(N), and filter signal components having frequencies outside the channel or frequency band of the respective forward paths FP(1)-FP(N). Thus, the pass bands of the first bandpass filters 311(1)-311(N) correspond to the width of the channel associated with the respective forward paths FP(1)-FP(N). The first LNAs 312(1)-312(N) amplify the received communication signals to a level suitable for processing by the frequency converters 313(1)-313(N). The frequency converters 313(1)-313(N) convert the frequency of the communication signals in the respective forward paths FP(1)-FP(N) (e.g., to a frequency suitable for transmission from the satellite 300 to the UT 400). The second LNAs 314(1)-314(N) amplify the frequency-converted communication signals, and the second bandpass filters 315(1)-315(N) filter signal components having frequencies outside of the associated channel width. The PAs 316(1)-316(N) amplify the filtered signals to a power level suitable for transmission to the UT 400 via a respective one of the antennas 352(1)-352(N). The return transponder 320, which includes a number N of return paths RP(1)-RP(N), receives communication signals from the UT 400 along return service link 302R via the antennas 361(1)-361(N), and transmits communication signals to the gateway 200 along return feeder link 301R via one or more antennas 362. Each of the return paths RP(1)-RP(N), which may process communication signals within a corresponding channel or frequency band, may be coupled to a respective one of the antennas 361(1)-361(N), and may include a respective one of first bandpass filters 321(1)-321(N), a respective one of first LNAs 322(1)-322(N), a respective one of frequency converters 323(1)-323(N), a respective one of second LNAs 324(1)-324(N), and a respective one of second bandpass filters 325(1)-325(N).

Within each of the respective return paths RP(1)-RP(N), the first bandpass filters 321(1)-321(N) pass signal components having frequencies within the channel or frequency band of the respective return paths RP(1)-RP(N), and filter signal components having frequencies outside the channel or frequency band of the respective return paths RP(1)-RP(N). Thus, the pass bands of the first bandpass filters 321(1)-321(N) may for some implementations correspond to the width of the channel associated with the respective return paths RP(1)-RP(N). The first LNAs 322(1)-322(N) amplify all the received communication signals to a level suitable for processing by the frequency converters 323(1)-323(N). The frequency converters 323(1)-323(N) convert the frequency of the communication signals in the respective return paths RP(1)-RP(N) (e.g., to a frequency suitable for transmission from the satellite 300 to the gateway 200). The second LNAs 324(1)-324(N) amplify the frequency-converted communication signals, and the second bandpass filters 325(1)-325(N) filter signal components having frequencies outside of the associated channel width. Signals from the return paths RP(1)-RP(N) are combined and provided to the one or more antennas 362 via a PA 326. The PA 326 amplifies the combined signals for transmission to the gateway 200.

The oscillator 330, which may be any suitable circuit or device that generates an oscillating signal, provides a forward local oscillator LO(F) signal to the frequency converters 313(1)-313(N) of the forward transponder 310, and provides a return local oscillator LO(R) signal to the frequency converters 323(1)-323(N) of the return transponder 320. For example, the LO(F) signal may be used by the frequency converters 313(1)-313(N) to convert communication signals from a frequency band associated with the transmission of signals from the gateway 200 to the satellite 300 to a frequency band associated with the transmission of signals from the satellite 300 to the UT 400. The LO(R) signal may be used by the frequency converters 323(1)-323(N) to convert communication signals from a frequency band associated with the transmission of signals from the UT 400 to the satellite 300 to a frequency band associated with the transmission of signals from the satellite 300 to the gateway 200.

The controller 340, which is coupled to the forward transponder 310, the return transponder 320, and the oscillator 330, may control various operations of the satellite 300 including (but not limited to) channel allocations. In one aspect, the controller 340 may include a memory coupled to a processor (not shown for simplicity). The memory may include a non-transitory computer-readable medium (e.g., one or more nonvolatile memory elements, such as EPROM, EEPROM, Flash memory, a hard drive, etc.) storing instructions that, when executed by the processor, cause the satellite 300 to perform operations including (but not limited to) those described herein.

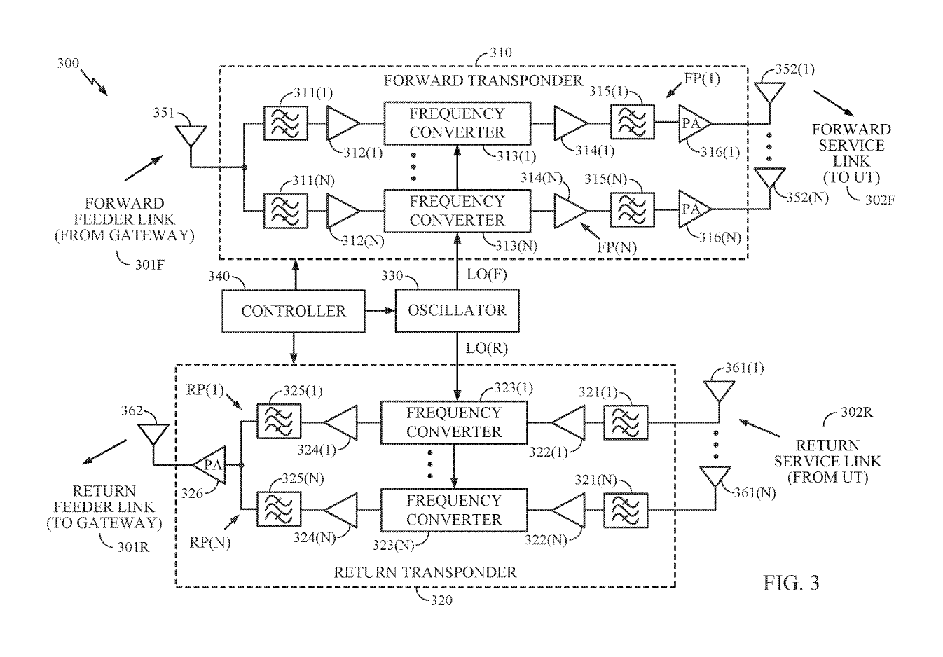

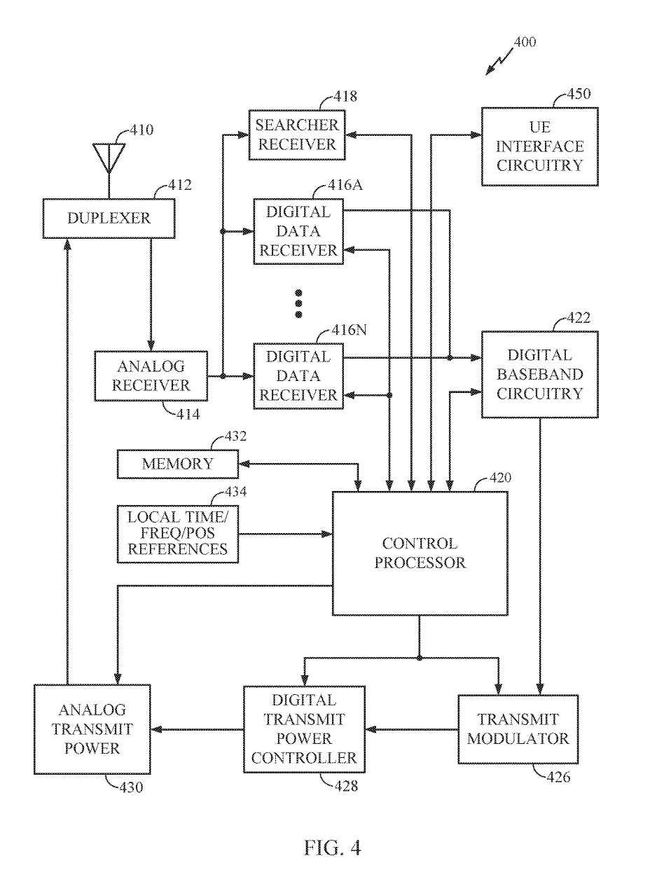

An example of a transceiver for use in the UT 400 or 401 is illustrated in FIG. 4. In FIG. 4, at least one antenna 410 is provided for receiving forward link communication signals (e.g., from the satellite 300), which are transferred to an analog receiver 414, where they are down-converted, amplified, and digitized. A duplexer element 412 may be used to allow the same antenna to serve both transmit and receive functions. Alternatively, the UT 400 may employ separate antennas for operating at different transmit and receive frequencies.

The digital communication signals output by the analog receiver 414 are transferred to at least one digital data receiver 416A-416N and at least one searcher receiver 418. The digital data receivers 416A-416N can be used to obtain desired levels of signal diversity, depending on the acceptable level of transceiver complexity, as would be apparent to one skilled in the relevant art.

At least one control processor 420 is coupled to the digital data receivers 416A-416N and the searcher receiver 418. The control processor 420 provides, among other functions, basic signal processing, timing, power and handoff control or coordination, and selection of frequency used for signal carriers. Another basic control function that may be performed by the control processor 420 is the selection or manipulation of functions to be used for processing various signal waveforms. Signal processing by the control processor 420 can include a determination of relative signal strength and computation of various related signal parameters. Such computations of signal parameters, such as timing and frequency may include the use of additional or separate dedicated circuitry to provide increased efficiency or speed in measurements or improved allocation of control processing resources.

The outputs of the digital data receivers 416A-416N are coupled to digital baseband circuitry 422 within the UT 400. The digital baseband circuitry 422 comprises processing and presentation elements used to transfer information to and from the UE 500 as shown in FIG. 1, for example. Referring to FIG. 4, if diversity signal processing is employed, the digital baseband circuitry 422 may comprise a diversity combiner and decoder. Some of these elements may also operate under the control of, or in communication with, the control processor 420.

When voice or other data is prepared as an output message or communications signal originating with the UT 400, the digital baseband circuitry 422 is used to receive, store, process, and otherwise prepare the desired data for transmission. The digital baseband circuitry 422 provides this data to a transmit modulator 426 operating under the control of the control processor 420. The output of the transmit modulator 426 is transferred to a digital transmit power controller 428 which provides output power control to an analog transmit power amplifier 430 for final transmission of the output signal from the antenna 410 to a satellite (e.g., the satellite 300).

In FIG. 4, the UT 400 also includes a memory 432 associated with the control processor 420. The memory 432 may include instructions for execution by the control processor 420 as well as data for processing by the control processor 420. In the example illustrated in FIG. 4, the memory 432 may include instructions for performing time or frequency adjustments to be applied to an RF signal to be transmitted by the UT 400 via the return service link 302R to the satellite 300.

In the example illustrated in FIG. 4, the UT 400 also includes an optional local time, frequency and/or position references 434 (e.g., a GPS receiver), which may provide local time, frequency and/or position information to the control processor 420 for various applications, including, for example, time or frequency synchronization for the UT 400.

The digital data receivers 416A-416N and the searcher receiver 418 are configured with signal correlation elements to demodulate and track specific signals. The searcher receiver 418 is used to search for pilot signals, or other relatively fixed pattern strong signals, while the digital data receivers 416A-416N are used to demodulate other signals associated with detected pilot signals. However, the digital data receivers 416A-416N can be assigned to track the pilot signal after acquisition to accurately determine the ratio of signal chip energies to signal noise, and to formulate pilot signal strength. Therefore, the outputs of these units can be monitored to determine the energy in, or frequency of, the pilot signal or other signals. These digital data receivers 416A-416N also employ frequency tracking elements that can be monitored to provide current frequency and timing information to the control processor 420 for signals being demodulated.

The control processor 420 may use such information to determine to what extent the received signals are offset from the oscillator frequency, when scaled to the same frequency band, as appropriate. This, and other information related to frequency errors and frequency shifts, can be stored in the memory 432 as desired.

The control processor 420 may also be coupled to UE interface circuitry 450 to allow communications between the UT 400 and one or more UEs. The UE interface circuitry 450 may be configured as desired for communication with various UE configurations and accordingly may include various transceivers and related components depending on the various communication technologies employed to communicate with the various UEs supported. For example, the UE interface circuitry 450 may include one or more antennas, a wide area network (WAN) transceiver, a wireless local area network (WLAN) transceiver, a Local Area Network (LAN) interface, a Public Switched Telephone Network (PSTN) interface and/or other known communication technologies configured to communicate with one or more UEs in communication with the UT 400.

FIG. 5 is a block diagram illustrating an example of the UE 500, which also can apply to the UE 501 of FIG. 1. The UE 500 as shown in FIG. 5 may be a mobile device, a handheld computer, a tablet, a wearable device, a smart watch, or any type of device capable of interacting with a user, for example. Additionally, the UE 500 may be a network side device that provides connectivity to various ultimate end user devices and/or to various public or private networks. In the example shown in FIG. 5, the UE 500 may comprise a LAN interface 502, one or more antennas 504, a wide area network (WAN) transceiver 506, a wireless local area network (WLAN) transceiver 508, and a satellite positioning system (SPS) receiver 510. The SPS receiver 510 may be compatible with the Global Positioning System (GPS), the Global Navigation Satellite System (GLONASS) and/or any other global or regional satellite based positioning system. In an alternate aspect, the UE 500 may include the WLAN transceiver 508, such as a Wi-Fi transceiver, with or without the LAN interface 502, the WAN transceiver 506, and/or the SPS receiver 510, for example. Further, the UE 500 may include additional transceivers such as Bluetooth®, ZigBee®, and other known technologies, with or without the LAN interface 502, the WAN transceiver 506, the WLAN transceiver 508 and/or the SPS receiver 510. Accordingly, the elements illustrated for the UE 500 are provided merely as an example configuration and are not intended to limit the configuration of UEs in accordance with the various aspects disclosed herein.

In the example shown in FIG. 5, a processor 512 is connected to the LAN interface 502, the WAN transceiver 506, the WLAN transceiver 508, and the SPS receiver 510. Optionally, a motion sensor 514 and other sensors may also be coupled to the processor 512.

A memory 516 is connected to the processor 512. In one aspect, the memory 516 may include data 518 that may be transmitted to and/or received from the UT 400, as shown in FIG. 1. Referring to FIG. 5, the memory 516 may also include stored instructions 520 to be executed by the processor 512 to perform the process steps for communicating with the UT 400, for example. Furthermore, the UE 500 may also include a user interface 522, which may include hardware and software for interfacing inputs or outputs of the processor 512 with the user through light, sound, or tactile inputs or outputs, for example. In the example shown in FIG. 5, the UE 500 includes a microphone/speaker 524, a keypad 526, and a display 528 connected to the user interface 522. Alternatively, the user's tactile input or output may be integrated with the display 528 by using a touch-screen display, for example. Once again, the elements illustrated in FIG. 5 are not intended to limit the configuration of the UEs disclosed herein and it will be appreciated that the elements included in the UE 500 will vary based on the end use of the device and the design choices of the system engineers.

Additionally, the UE 500 may be a user device such as a mobile device or external network side device in communication with but separate from the UT 400 as illustrated in FIG. 1, for example. Alternatively, the UE 500 and the UT 400 may be integral parts of a single physical device.

FIG. 6 is a diagram illustrating an example of a communication satellite 600 having an antenna 610 that is capable of forming multiple radio beams 630a, 630b, etc., within a range of azimuth angles to cover a surface area of the Earth. In one aspect, the antenna 610 on the communication satellite 600 has an antenna beam pattern composed of the multiple radio beams 630a, 630b, etc. on a geographic area 620 of the Earth. In the example depicted in FIG. 6, the composite antenna beam pattern of the antenna 610 on the communication satellite 600 may be formed by stacking the multiple radio beams 630a, 630b, etc., in the North-South orientation, where each of the multiple radio beams 630a, 630b, etc., has an elongate elliptical footprint on the surface of the Earth. In one example, each of the multiple radio beams 630a, 630b, etc., may be generated by one or more radiators, such as open-ended waveguides or horns, in a linear antenna array, examples of which will be described in further detail below.

In the example illustrated in FIG. 6, the antenna 610 may have a constant North-South orientation. In one aspect, the antenna 610 may generate the stacked radio beams 630a, 630b, etc. in a Ku-band (or Kurtz-under band) in the North-South orientation over a wide range of elevation angles to provide a sufficiently wide coverage along the North-South orientation. In one aspect, each of the stacked radio beams 630a, 630b, etc., has a relatively wide beamwidth in the East-West orientation and a relatively narrower beamwidth in the North-South orientation, as depicted in FIG. 6. In one aspect, all of the stacked radio beams 630a, 630b, etc., are centered about the normal, that is the perpendicular, line from the antenna 610 of the communication satellite 600 to the surface of the Earth in the East-West orientation. Alternatively, the antenna beam pattern composed of multiple stacked radio beams 630a, 630b, etc., need not be centered about the normal. In one aspect, the antenna 610 may be mechanically pointed to scan the radio beam pattern vertically, that is, along the North-South orientation. In another alternative aspect, the radio beam pattern may be electronically scanned by the antenna 610 along the North-South orientation. Various other antenna beam patterns with different beamwidths in different orientations may also be generated within the scope of the disclosure, as will be apparent to those skilled in the art.

In the specific example shown in FIG. 6, the antenna 610 generates sixteen (16) stacked radio beams 630a, 630b, etc., in the North-South orientation, where beams nine (9) through sixteen (16) are mirrored images of beams eight (8) through one (1) with respect to the normal. In other words, the ninth beam may be a mirrored image of the eighth beam, and the tenth beam may be a mirrored image of the seventh beam, and so on. In one aspect, the multiple radio beams 630a, 630b, etc., generated by the antenna 610 on the communication satellite 600 forming the scan pattern in the example depicted in FIG. 6 may have a narrower beamwidth along the North-South orientation and a wider beamwidth along the East-West orientation to provide efficient coverage of the geographic area 620 of the Earth, while meeting interference limits imposed by regulatory authorities for that geographic area. Various other antenna beam scan patterns and beamwidths may also be selected, depending on the particular requirements and specifications of the system in which the communication satellite 600 is used. For example, assuming that the geographic area 620 as shown in FIG. 6 has a 50° square footprint, the following table sets forth example system requirements to produce the sixteen stacked radio beams 630a, 630b, etc. according to the pattern shown in FIG. 6:

TABLE 1
Example Antenna Beam Pattern Requirements

| Beam | 3db-BW | | Max | Vertical Beam | Estimated |
|---|---|---|---|---|---|
| No. | (N-S) | 3db-BW (E-W) | SLL | Pointing Angle | Directivity |
| 1 | 2.90° | 44.7° | −30 dB | 25.8° | 24.60 dBi |
| 2 | 3.10° | 46.0° | −30 dB | 22.8° | 24.20 dBi |
| 3 | 3.30° | 47.2° | −30 dB | 19.6° | 23.80 dBi |
| 4 | 3.40° | 48.0° | −30 dB | 16.3° | 23.55 dBi |
| 5 | 3.55° | 48.8° | −30 dB | 12.8° | 23.30 dBi |
| 6 | 3.60° | 49.4° | −30 dB | 9.2° | 23.15 dBi |
| 7 | 3.70° | 49.7° | −30 dB | 5.6° | 23.05 dBi |
| 8 | 3.70° | 49.9° | −30 dB | 1.9° | 23.00 dBi |
| 9 | 3.70° | 49.9° | −30 dB | −1.9° | 23.00 dBi |
| 10 | 3.70° | 49.7° | −30 dB | −5.6° | 23.05 dBi |
| 11 | 3.60° | 49.4° | −30 dB | −9.2° | 23.15 dBi |
| 12 | 3.55° | 48.8° | −30 dB | −12.8° | 23.30 dBi |
| 13 | 3.40° | 48.0° | −30 dB | −16.3° | 23.55 dBi |
| 14 | 3.30° | 47.2° | −30 dB | −19.6° | 23.80 dBi |
| 15 | 3.10° | 46.0° | −30 dB | −22.8° | 24.20 dBi |
| 16 | 2.90° | 44.7° | −30 dB | −25.8° | 24.60 dBi |

As described above, circularly polarized antennas are implemented in satellite communication systems to avoid the problem associated with linear polarization, which would require the direction of polarization of the receive antenna to be aligned with that of the transmit antenna. In a satellite communication system, a bidirectional or duplex communication link includes a forward link for a satellite to transmit signals to a ground station, and a return link for the ground station to transmit signals to the satellite. A satellite communication system may be allocated a limited amount of total bandwidth, and this bandwidth may need to be shared between the forward link and the return link. For example, a Ku-band microwave communication satellite may have a transmit (or forward link) frequency band from 10.7 GHz to 12.7 GHz, and a receive (or return link) frequency band from 12.75 GHz to 14.5 GHz. In other examples, the antenna implementations described herein may be applied to other suitable frequency bands used in satellite communications, such as the Ka-band (or Kurtz-above band) covering frequencies from about 26.5-40 GHz and others. For a duplex satellite transceiver, a single antenna may be used to transmit forward link signals and to receive return link signals. To differentiate between the transmit and receive signals, the antenna beam for a transmit signal has a circular polarization that is opposite that of the antenna beam for a receive signal. For example, if a transmit signal is right-hand circularly polarized (RHCP), then the receive signal is left-hand circularly polarized (LHCP). Conversely, if a transmit signal is LHCP, then the receive signal is RHCP.

In the example of the antenna beam scan pattern illustrated in FIG. 6 and described above, the antenna beam has a narrower beamwidth in the North-South orientation and a wider beamwidth in the East-West orientation, which may provide an efficient way to meet the above-mentioned regulatory interference limits. According to the physical principles of antenna design, a narrower beamwidth in a given orientation may imply an antenna aperture with a larger physical dimension in that orientation, and conversely, a wider beamwidth in a given orientation may imply an antenna aperture with a smaller physical dimension in that orientation. In other words, to generate a beam that has a relatively narrow footprint or beamwidth in one plane (e.g., the North-South plane in FIG. 6) and a substantially wider footprint or beamwidth in the other plane (e.g., the East-West plane in FIG. 6), the antenna 610 on the communication satellite 600 may have a relatively large aperture or physical dimension in the plane with the relatively narrow footprint and a smaller aperture or physical dimension in the other plane with the relatively wide footprint.

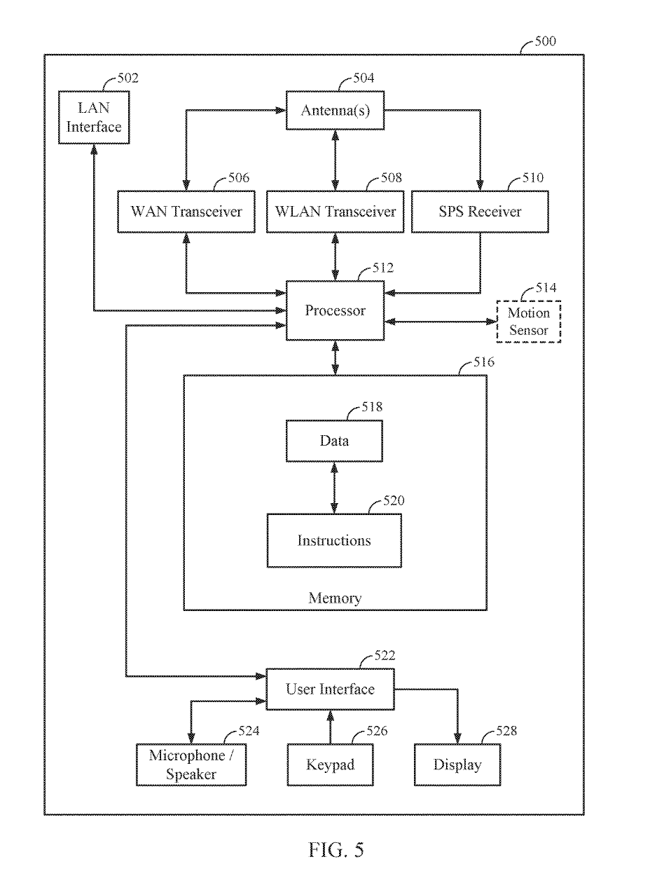

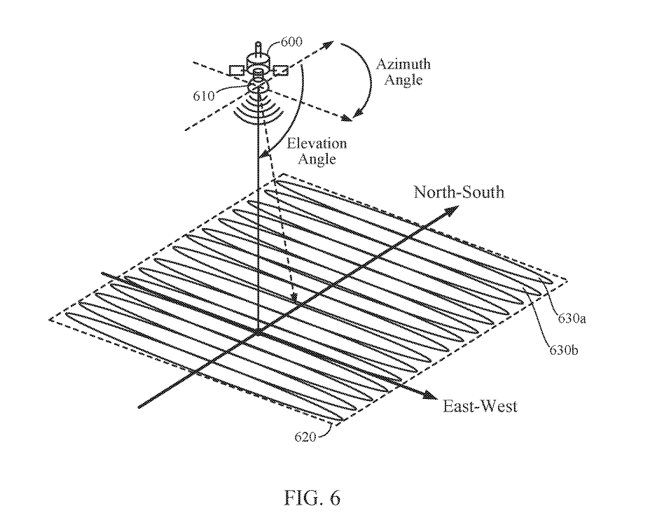

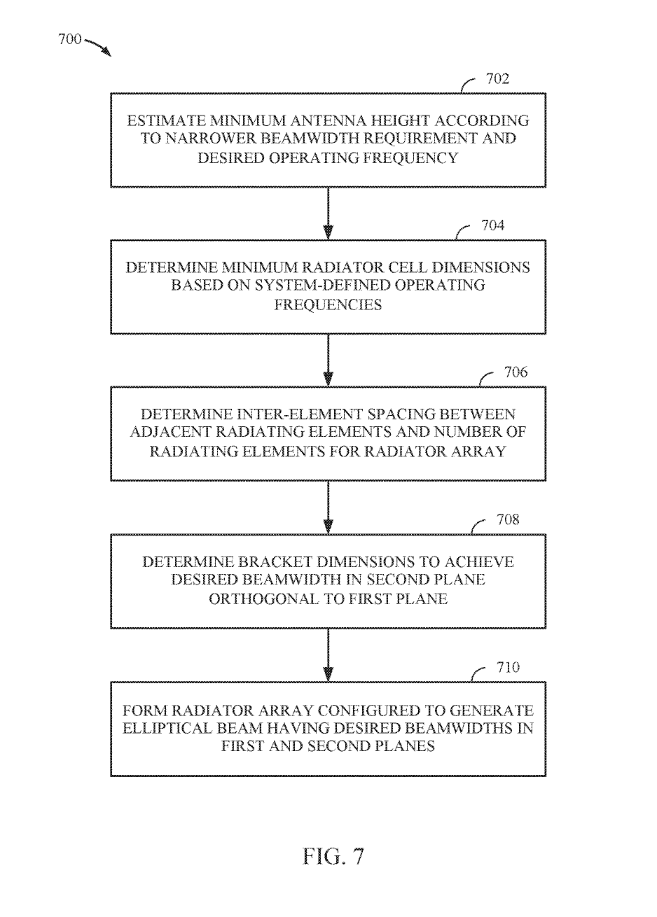

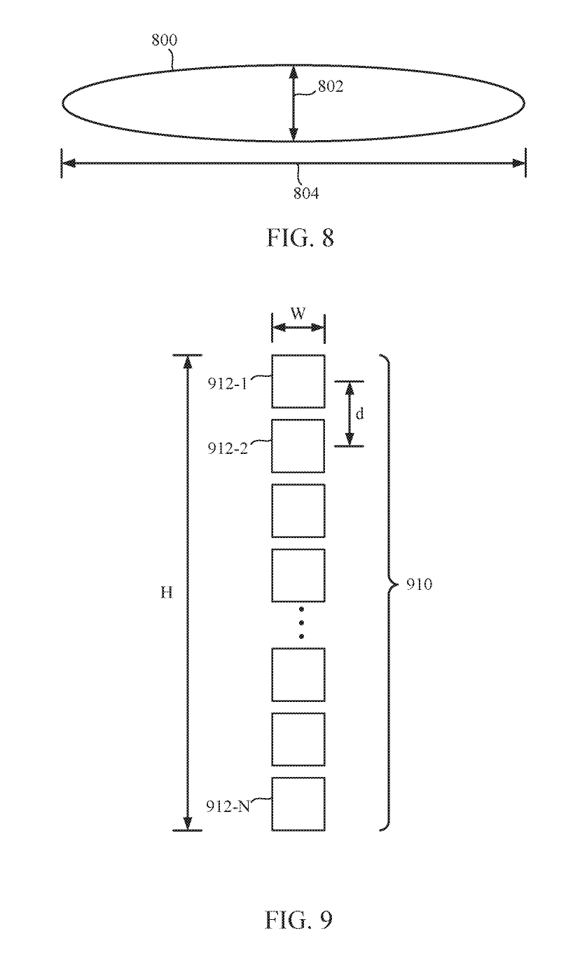

Referring now to FIG. 7, an example method 700 as illustrated therein may be used to design an antenna structure that can form an elliptical beam such as the radio beams 630a, 630b shown in FIG. 6. In general, the method 700 is described herein with reference to FIG. 8-11 to explain certain illustrative aspects. However, those skilled in the art will appreciate that the method 700 shown in FIG. 7 is not limited to the example implementation details shown in FIG. 8-11, as other implementations are described and contemplated herein. According to one aspect, FIG. 8 illustrates an example elliptical beam 800 that has a footprint with a first desired beamwidth 802 in a first plane and a second desired beamwidth 804 in a second plane orthogonal to the first plane, wherein the second desired beamwidth 804 is substantially wider than the first desired beamwidth 802. For example, referring to the preceding table and assuming that the elliptical beam 800 corresponds to the first radio beam 630a or the sixteenth radio beam in FIG. 6, the first desired beamwidth 802 may be 2.90° in the North-South plane and the second desired beamwidth 804 may be 44.70° in the East-West plane. Assuming that the elliptical beam 800 instead corresponds to the second radio beam 630b or the fifteenth radio beam in FIG. 6, the first desired beamwidth 802 would be 3.10° in the North-South plane and the second desired beamwidth 804 would be 46.00° in the East-West plane. Accordingly, in FIG. 8, the desired beamwidths 802, 804 in the two orthogonal planes may generally comprise half-power beamwidths to achieve a certain area or angular coverage, which may be specified according to system requirements.

According to various aspects, the method 700 shown in FIG. 7 may therefore be used to design the antenna structure to produce the elliptical beam 800 as shown in FIG. 8, with a narrow half-power beamwidth 802 in a first plane and a substantially wider half-power beamwidth 804 in a second plane orthogonal to the first plane. The method 700 as described herein may therefore be subject to design constraints that are based at least in part on the desired half-power beamwidths 802, 804 as well as a frequency band in which the antenna structure is to be configured to operate. For example, when the antenna structure is designed to be used in a Ku-band microwave communication satellite, the antenna structure may be subject to payload requirements whereby a transmit (or Tx) frequency band includes operating frequencies from about 10.7-12.7 GHz, a receive (or Rx) frequency band includes operating frequencies from about 12.75-14.5 GHz, and transmit and receive signals need to have opposite polarizations. In one aspect, the method 700 may use the lowest operating frequency as the primary design frequency, as the lowest operating frequency may represent the worst case with respect to size and weight estimates. However, those skilled in the art will appreciate that other suitable operating frequencies may be used as the primary design frequency (e.g., to obtain the desired beamwidths 802, 804 according to a configuration that also achieves the best performance, the lowest size and weight, etc.).

According to various aspects, referring to FIG. 7 in connection with FIG. 8 and FIG. 9, a minimum antenna height (H) may be estimated according to the narrower beamwidth requirement 802 and the desired operating frequency at block 702. For example, in one aspect, the minimum antenna height H may be estimated as follows:

$$H > 50.76 \frac{{λ}_{desired}}{{Beamwidth}_{narrow}} , \qquad ( Equation 1 )$$

where λ_{desired} is a wavelength at the desired operating frequency and Beamwidth_{narrow} is the narrower beamwidth requirement 802 as shown in FIG. 8.

According to various embodiments, for H>>λ_{desired}, the antenna structure may be formed with one or more circularly polarized (CP) radiators that are arranged in a linear array to achieve the desired beamwidths 802, 804. For example, FIG. 9 illustrates an example linear radiator array 910 comprising radiating elements 912-1 through 912-N. In one aspect, the radiating elements 912-1 through 912-N may each be a square waveguide radiator used to provide the desired dual circular polarization for transmit and receive modes and to allow the wider beamwidth 804 to be reconfigured as desired, as will be described in further detail below. As shown in FIG. 9, the linear radiator array 910 may have a height H (e.g., as determined according to Equation 1 above), the square waveguide radiators used as the radiating elements 912-1 through 912-N may each have a width (W), and an inter-element spacing (d) may be provided between adjacent radiating elements 912-1 through 912-N. For example, in various embodiments, the minimum W×W cell dimensions associated with the radiating element 912-1 through 912-N may be determined at block 704 as follows:

$$W \geq \frac{7.377}{{F}_{low}} ( inches ) , \qquad ( Equation 2 )$$

where F_{low} is the lowest operating frequency in GHz (e.g., the lowest operating frequency in the Ku-band is 10.7 GHz, in which case F_{low} would have the value 10.7).

According to various aspects, at block 706, the inter-element spacing d between the adjacent radiating elements 912-1 through 912-N and a number (N) of the radiating elements 912-1 through 912-N to be used in the linear radiator array 910 may be determined. For example, according to various embodiments, the inter-element spacing d between the adjacent radiating elements 912-1 through 912-N may be determined as follows:

W<d<0.95λ_{high} (Equation 3)

, where λ_{high} is a wavelength at the highest operating frequency and W has a value that satisfies the constraint specified in Equation 2. Furthermore, based on an inter-element spacing d that satisfies the constraint specified in Equation 3 and the minimum antenna height H, as determined according to Equation 1, the value associated with N (i.e., the number of radiating elements 912-1 through 912-N to be used in the linear radiator array 910) may be determined as follows:

$$N = Integer ( \frac{H}{d} ) \qquad ( Equation 4 )$$

According to various aspects, the parameters determined at blocks 702-706 based on Equations 1-4 as described above may be used to design the linear radiator array 910 as shown in FIG. 9 such that providing the linear radiator array 910 in the antenna structure may achieve the desired narrow beamwidth 802 as shown in FIG. 8. Furthermore, based on the design principles described above, the second beamwidth 804 that the linear radiator array 910 produces in the orthogonal plane may be controlled according to the width W used as the cell dimensions associated with the radiating elements 912-1 through 912-N, as follows:

$${Beamwidth}_{wide} ≅ 50.76 \frac{{λ}_{desired}}{W} ( degrees ) , \qquad ( Equation 5 )$$

where Beamwidth_{wide} is the second beamwidth 804 that the linear radiator array 910 produces based on the parameters determined at blocks 702-706. However, the value that Beamwidth_{wide} has based on Equation 5 is typically larger than the desired second beamwidth 804. For example, assuming that system requirements specify that the elliptical beam 800 should be generated such that the desired narrow beamwidth 802 is approximately 3° and the desired wide beamwidth 804 is approximately 45° and that the antenna structure is to be used in a Ku-band microwave communication satellite, Equation 3 would result in the radiating elements 912-1 through 912-N having an approximately 0.7″ width W based on the Ku-band having a lowest operating frequency at approximately 10.7 GHz. Further assuming that the desired operating frequency is approximately centered in the frequency band from about 10.7-12.7 GHz, the resulting Beamwidth_{wide} would be approximately 75°, which is wider than the desired wide beamwidth 804 (i.e., ˜45° in this example).

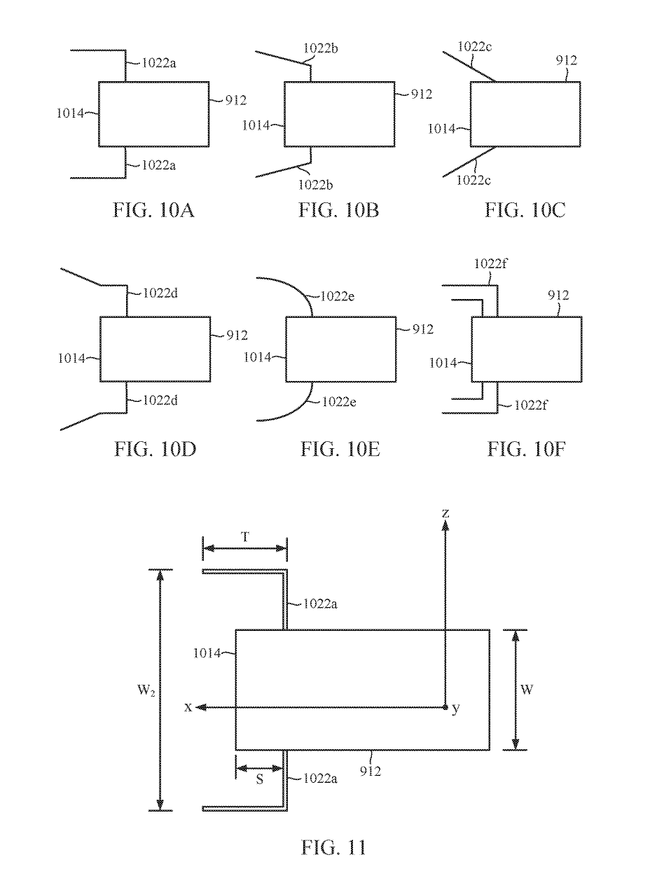

As such, according to various aspects, an additional mechanism may be provided to narrow Beamwidth_{wide} as defined in Equation 5 and thereby achieve the desired second beamwidth 804 as shown in FIG. 8. In one aspect, conductive brackets may be added to each radiating element 912-1 through 912-N in the appropriate plane to narrow Beamwidth_{wide} to the desired second beamwidth 804. For example, FIG. 10A-10F illustrate several example conductive bracket designs 1022a through 1022f, wherein the radiator 912 has an aperture 1014 and the conductive brackets 1022a-1022f are disposed around the radiator aperture 1014 in each example design. In general, the conductive brackets 1022 may be formed using conventional fabrication methods such as sheet-metal stamping, extrusion, plated plastics, etc. Furthermore, the dimensions and/or locations associated with the conductive brackets 1022 as well as the particular shape or design may be chosen (e.g., from among designs 1022a through 10220 to narrow Beamwidth_{wide} to the desired second beamwidth 804 in a manner that may achieve the best antenna performance. For example, in addition to the desired second beamwidth 804, design constraints may include a maximum side lobe level (SLL) representing a difference in power density in one or more side lobes relative to the peak of the main beam, a desired axial ratio, power transfer, etc. Accordingly, the following description sets forth an example approach that may be used to design the conductive brackets 1022 based on the design 1022a shown in FIG. 10A. However, those skilled in the art will appreciate that the conductive brackets 1022 may include other suitable designs, including but not limited to the designs 1022b through 1022f further shown in FIG. 10B-10F.

According to various aspects, with specific reference to FIG. 11, the conductive brackets 1022a may be designed to have an L-shape and be coupled to the radiating element 912 at a first distance (S) behind the aperture 1014 and span a total width (W₂) when positioned, placed, or otherwise arranged around the aperture 1014. Furthermore, the L-shaped conductive brackets 1022a may extend forwardly from the aperture 1014 such that the L-shaped conductive brackets 1022a have a total length (T). As such, referring again to FIG. 7, the dimensions associated with the L-shaped conductive brackets 1022a may be determined at block 708 to achieve the desired second beamwidth 804. For example, FIG. 11 illustrates an example in which the L-shaped conductive brackets 1022a are used to achieve the desired second beamwidth 804 in an x-z plane, wherein W₂, S, and T may have initial values that are determined as follows:

$$\begin{matrix}{W}_{2} ≅ 50.76 \frac{{λ}_{desired}}{{Beamwidth}_{desired}} & ( Equation 6 ) \\ S ≅ k \frac{{λ}_{desired}}{4} & ( Equation 7 ) \\ T ≅ S + ( m \frac{{λ}_{desired}}{4} ) , & ( Equation 8 )\end{matrix}$$

where Beamwidth_{desired} is the desired second beamwidth 804, k is an odd integer (i.e., 1, 3, 5, etc.), and m is also an odd integer that may have the same or a different value from k. Furthermore, according to various embodiment, the initial values that are determined for W₂, S, and/or T may be optimized to obtain the desired second beamwidth 804 and the best antenna performance according to antenna measurements, electromagnetic simulation software, and/or any suitable combination thereof. According to various aspects, at block 710, the antenna structure may then be formed based on the various design parameters described above such that the linear radiator array 910 combined with the conductive brackets 1022 disposed around the aperture 1014 in each radiating element 912-1 through 912-N result in the antenna structure generating the elliptical beam 800 having the first desired beamwidth 802 and the second desired beamwidth 804.

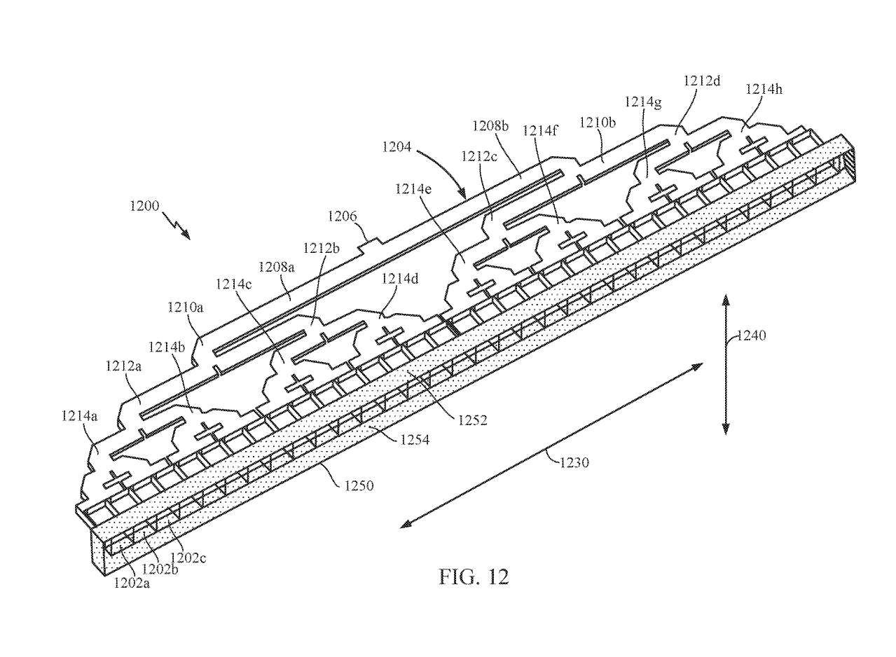

According to various aspects, an example antenna structure embodying the above design principles will now be described. In particular, FIG. 12 is a perspective view of an example antenna 1200 that may be used to generate an elliptical beam with configurable beamwidths in two orthogonal planes. Referring to FIG. 12, the antenna 1200 comprises a linear array of radiators 1202a, 1202b, 1202c, etc. In one example, each of the radiators 1202a, 1202b, 1202c, etc., may comprise a rectangular waveguide or horn. In an alternate example, each of the radiators 1202a, 1202b, 1202c, etc., may comprise a circular waveguide or horn. In another alternate example, each of the radiators 1202a, 1202b, 1202c, etc., may comprise an elliptical waveguide or horn. Other types of microwave radiators may also be implemented within the scope of the disclosure. Moreover, although a linear array of a single row of radiators 1202a, 1202b, 1202c, etc., are shown in FIG. 12, an antenna comprising a two-dimensional array of radiators, for example, a plurality of linear arrays of radiators like the ones shown in FIG. 12 stacked together, may also be provided within the scope of the disclosure.

In one aspect, a waveguide network 1204 may be provided to propagate radio-frequency (RF) signals to the radiators 1202a, 1202b, 1202c, etc., and to convey receive RF signals received from the radiators 1202a, 1202b, 1202c, etc. In the example illustrated in FIG. 12, the waveguide network 1204 has a tree structure which includes multiple stages of 1:2 power splitters to distribute microwave energy carrying a transmit signal to the radiators 1202a, 1202b, 1202c, etc. For example, the waveguide network 1204 as shown in FIG. 12 includes a first-stage power splitter 1206 that splits microwave energy carrying the transmit signal equally among two waveguides 1208a and 1208b, and two second-stage power splitters 1210a and 1210b that further split the microwave energy from the waveguides 1208a and 1208b, respectively. Furthermore, four third-stage power splitters 1212a, 1212b, 1212c and 1212d are provided to split the microwave energy from the two second-stage power splitters 1210a and 1210b, and eight fourth-stage power splitters 1214a, 1214b, 1214c, . . . , 1214h are provided to further split the microwave energy from the four three-stage power splitters 1212a, 1212b, 1212c, and 1212d.

Alternatively, a radio-frequency (RF) transmission network other than the waveguide network 1204 as illustrated in FIG. 12 may be provided. In alternative examples, any types of feed network may be implemented for the antenna 1200, for example, a stripline network, a microstripline network, or another type of microwave network. Furthermore, the waveguide network 1204 need not be limited to a network of rectangular waveguides. For example, circular or elliptical waveguides may also be implemented in the waveguide network 1204.

In one aspect, the microwave energy may be further split by one or more additional stages of power splitters before it reaches the waveguides or horns that form the linear array of radiators of the antenna 1200. In the example shown in FIG. 12, the waveguide network 1204 includes five stages of power splitters to split the microwave energy among thirty-two radiators 1202a, 1202b, 1202c, etc. In one aspect, 1:2 power splitters may be provided in N stages in the waveguide network 1204 to distribute the transmit microwave energy among 2^{N} radiators 1202a, 1202b, 1202c, etc. In the opposite direction, microwave energy carrying a receive signal received by each of the radiators 1202a, 1202b, 1202c, etc., are combined by multiple stages of power splitters, which now function as 2:1 power combiners for the received microwave energy. Other types of splitters/combiners with other split/combination ratios may also be implemented in the waveguide network 1204. In one aspect, impedance transformers may be provided between the waveguide network 1204 and the radiators 1202a, 1202b, 1202c, etc. Such impedance transformers may have stepped waveguide transitions or smoothly tapered waveguide transitions known to persons skilled in the art.

In one aspect, in FIG. 12 the arrow 1230 along the linear array of the radiators 1202a, 1202b, 1202c, etc., illustrates a vertical orientation, and the arrow 1240 orthogonal to the linear array of the radiators 1202a, 1202b, 1202c, etc., illustrates a horizontal orientation. The horizontal orientation indicated by the arrow 1240 in FIG. 12 may correspond to the East-West orientation in FIG. 6 and the vertical orientation indicated by the arrow 1230 in FIG. 12 may correspond to the North-South orientation in FIG. 6 as viewed from the communication satellite 600, for example. Alternatively, the horizontal orientation indicated by the arrow 1240 and the vertical orientation indicated by the arrow 1230 may correspond to different orientations of the Earth as viewed from the satellite.

In the example illustrated in FIG. 12, a linear antenna array of a plurality of circularly polarized radiators, for example, the radiators 1202a, 1202b, 1202c, etc., provide a beam with a relatively narrow beamwidth along the vertical orientation indicated by the arrow 1230. In another aspect (not shown in FIG. 12), the radiators 1202a, 1202b, 1202c, etc., are stacked along the horizontal orientation indicated by the arrow 1240 to generate a beam having a relatively narrow beamwidth along the horizontal orientation indicated by the arrow 1240. As such, the beam may generally have a narrower beamwidth along a plane in which the radiators 1202a, 1202b, 1202c, etc. are aligned and a wider beamwidth in the direction orthogonal to the plane of the array of radiators 1202a, 1202b, 1202c, etc. Furthermore, the beamwidth along the plane in which the radiators 1202a, 1202b, 1202c, etc. are aligned may be controlled according to a number of the radiators 1202a, 1202b, 1202c, etc. in the array and an inter-element spacing between the radiators 1202a, 1202b, 1202c, etc. in the array.

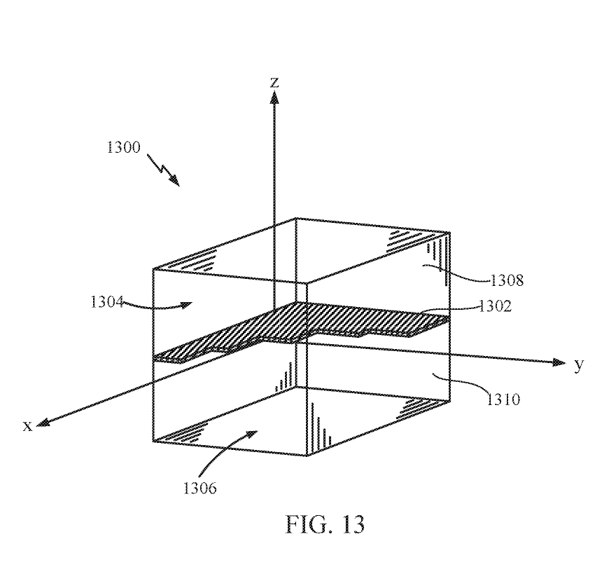

In one aspect, each of the radiators 1202a, 1202b, 1202c, etc., includes a linear-to-circular polarizer, such as a dual-polarization linear-to-circular polarizer, examples of which will be described in further detail below with respect to FIG. 13 through FIG. 16. Referring to the example illustrated in FIG. 12, the antenna 1200 further includes a bracket 1250 made of a conductor, such as a metal, which serves to narrow (or shape) the beam in the horizontal orientation indicated by the arrow 1240. In one aspect, the bracket 1250 includes a first conductor 1252 and a second conductor 1254 to narrow the beam generated by the linear array of the radiators 1202a, 1202b, 1202c, etc., in the horizontal orientation indicated by the arrow 1240 compared to if the two conductors 1252 and 1254 were absent. The two conductors 1252 and 1254 are oppositely arranged with respect to each other. In one example, each of the two conductors 1252 and 1254 has a 90° transition between two conductive surfaces, thus providing the two conductors 1252 and 1254 with an L-shape as in FIG. 10A and FIG. 11. Alternatively, the two conductors 1252 and 1254 need not have 90° transitions, whereby the two conductors 1252 and 1254 may have another suitable shape or design. For example, as shown in FIG. 10B, the conductors 1252 and 1254 may have the design depicted at 1022b, whereby the transition angles may be greater than 90° such that the beamwidth of radio beam from the radiators 1202a, 1202b, 1202c, etc. is still limited by the two conductors 1252 and 1254 in the horizontal orientation indicated by the arrow 1240, with the two conductors 1252 and 1254 acting as upper and lower lips of a horn. In other alternatives, the conductors 1252, 1254 may have other suitable designs, which may include but are not limited to the example designs shown in FIG. 10A-10F.

Microwave energy provided to the radiators 1202a, 1202b, 1202c, etc., of the antenna 1200 as shown in FIG. 12 may be generated by a single source and distributed through the waveguide network 1204 with multiple power splitters/combiners in a tree structure. Alternatively, the array of radiators 1202a, 1202b, 1202c, etc., may comprise an active array of radiators each having an individual transmitter, receiver, or transceiver. In one example, each of the active radiators comprises a transmit port and a receive port. A transmitter may be provided in each transmit port and a receiver may be provided in each receive port. In one example, the transmit port and the receive port in each active radiator have opposite polarizations, for example, RHCP and LHCP. In an alternate example, each of the active radiators comprises a first transceiver port and a second transceiver port with opposite polarizations, for example, RHCP and LHCP. Each of the two ports in each active radiator has a transceiver, thereby doubling the antenna array transmit and receive capacity.

FIG. 13 is a perspective view of an example of a dual circular polarization (CP) radiator 1300 in the antenna 1200 of FIG. 12. Referring to the example shown in FIG. 13, the dual CP radiator 1300 comprises a square waveguide radiator drawn with respect to Cartesian coordinates of x-, y-, and z-axes for clarity of illustration. In this example, the dual CP radiator 1300 includes a stepped septum polarizer 1302 for coupling linearly polarized radiation to circularly polarized radiation. The stepped septum polarizer 1302 causes circularly polarized radiation to be transmitted (in the x-axis direction) at either of input/output ports 1304 or 1306 in response to a linearly polarized wave fed (along the x-axis direction) into either of feed ports 1308 or 1310. By the principal of reciprocity, the stepped septum polarizer 1302 converts circularly polarized radiation received at either of the input/output ports 1304 or 1306 into a linearly polarized wave traveling along either of the feed ports 1308 or 1310.

For example, the top input/output port 1304 may be left-hand circularly polarized (LHCP), whereas the bottom input/output port 1306 may be right-hand circularly polarized (RHCP). The two separate feed ports 1308 and 1310 allow the stepped septum polarizer 1302 to generate the two opposite circular polarizations (LHCP and RHCP).

In the example illustrated in FIG. 13, the waveguide radiator in which the dual CP radiator 1300 is implemented comprises a square dual circularly polarized (CP) radiator whose dimensions are dependent on the radio frequency of the transmit/receive signals. For example, at 10.7 GHz, which is the low end of the transmit frequency band in the example of the satellite communication system described above, the dual CP radiator 1300 may have dimensions of 0.7″×0.7″×1.5″ (along x-, y- and z-axes, respectively). In this example, the stepped septum polarizer 1302 separates the dual CP radiator 1300 into the top input/output port 1304, which has dimensions of 0.7″×0.34″ (along x- and y-axes), and the bottom input/output port 1306, which also has dimensions of 0.7″×0.34″, assuming that the stepped septum polarizer 1302 has a thickness of 0.02″ along the z-axis.

Although the stepped septum polarizer 1302 has been described with reference to FIG. 13, other types of circular polarizers may also be implemented in each of the radiators 1202a, 1202b, 1202c, etc., in FIG. 12 by persons skilled in the art. For example, instead of the stepped septum polarizer 1302, a smooth-transitioned septum polarizer, such as an exponentially tapered septum polarizer or a linear septum polarizer, may also be implemented in the dual CP radiator 1300. Moreover, although the dual CP radiator 1300 illustrated in FIG. 13 is a square CP waveguide radiator, other types of waveguides, for example, rectangular waveguides, circular waveguides, or elliptical waveguides, may also be provided as radiators. Furthermore, microwave transmission structures other than waveguides may also be implemented as radiators in alternative examples.

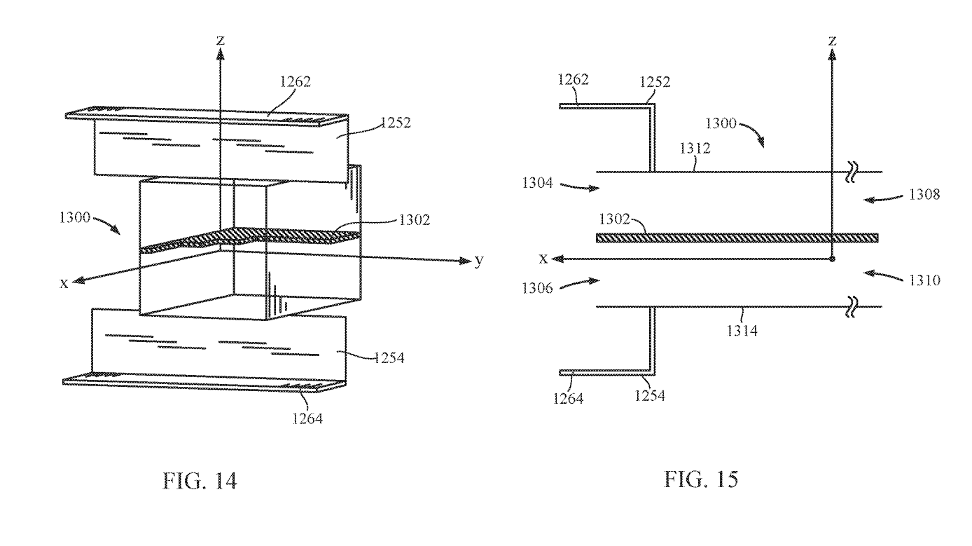

FIG. 14 is a perspective view of an example of an antenna radiator structure having the dual CP radiator 1300 and the two conductors 1252 and 1254 along the y-axis to narrow (shape) a beam along the z-axis compared to if the two conductors 1252 and 1254 were absent. In one aspect, the two conductors 1252 and 1254 may be part of the conductive bracket 1250 along the linear array of the radiators 1202a, 1202b, 1202c, etc., as shown in FIG. 12 and described above. Alternatively, the two conductors 1252 and 1254 as shown in FIG. 14 may be individually provided for each of the radiators 1202a, 1202b, 1202c, etc., of the antenna. In the example illustrated in FIG. 14, the dual CP radiator 1300 has the same structure as the square dual CP waveguide radiator illustrated in FIG. 13 and described above, including the stepped septum polarizer 1302 which separates the square CP waveguide radiator into the input/output ports 1304 and 1306.

FIG. 15 is a side sectional view of the antenna radiator structure illustrated in FIG. 14 along the x-axis. As shown in FIG. 15, the first conductor 1252 is provided on (proximal to) the top edge 1312 of the top input/output port 1304, whereas the second conductor 1254 is provided on (proximal to) the bottom edge 1314 of the bottom input/output port 1306. In this sense, the two conductors 1252 and 1254 are oppositely arranged with respect to each other, so that their respective geometric shapes when taken in combination may be described as being symmetrical about the x-y plane.

In an example in which the transmit/receive radio frequency is 10.7 GHz, and in which the dimensions of the square CP waveguide radiator is 0.7″×0.7″×1.5″, the two conductors 1252 and 1254 may have respective first and second metal walls 1262 and 1264 each having a length of 0.5″ along the x-axis, for example. In the example illustrated in FIG. 14 and FIG. 15, the first and second metal walls 1262 and 1264 are disposed parallel to the stepped septum polarizer 1302. The dimensions and locations of the two conductors 1252 and 1254 may be designed to achieve a desired antenna beamwidth with a desired axial ratio, for example, the ratio of the beamwidth along the y-axis to the beamwidth along the z-axis. Again, although the two conductors 1252 and 1254 are shown as having transition angles of 90° in FIG. 14 and FIG. 15, providing the two conductors 1252 and 1254 with an L-shape, the two conductors 1252 and 1254 may have transition angles other than 90° in alternative examples and are not limited to having an L-shape design. In other words, the first and second metal walls 1262 and 1264 of the two conductors 1252 and 1254 need not be parallel to the x-axis, and moreover, in various embodiments the two conductors 1252 and 1254 may comprise a single metal wall (e.g., as in designs 1022c and 1022e shown in FIG. 10C and FIG. 10E) or more than two metal walls (e.g., as in designs 1022d and 1022f shown in FIG. 10D and FIG. 10F).

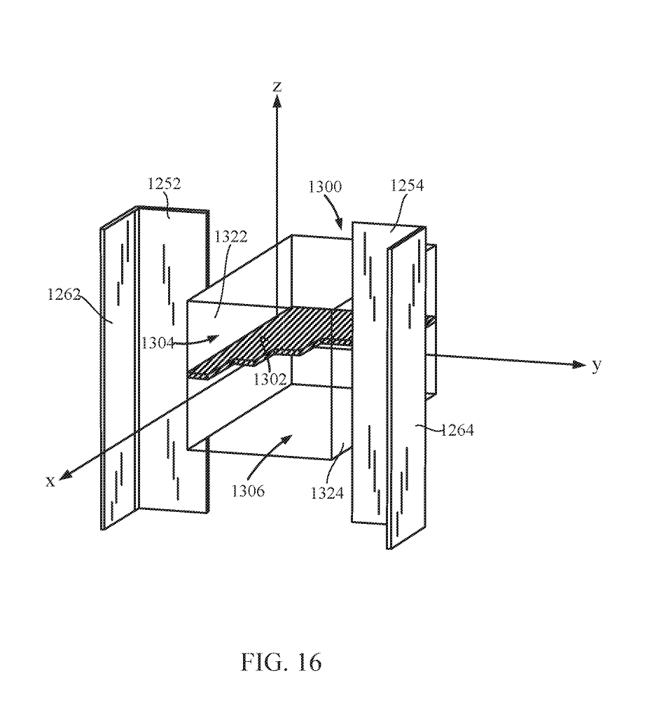

FIG. 16 is a perspective view of an alternate example of an antenna radiator structure having the dual CP radiator 1300 and the two conductors 1252 and 1254 along the z-axis to help narrow the beamwidth along the y-axis compared to if the two conductors 1252 and 1254 were absent. In this example, the dual CP radiator 1300 has the same or similar structure as that shown in FIG. 13 through FIG. 15 and described above. In the example shown in FIG. 16, the two conductors 1252 and 1254 are provided on side edges 1322 and 1324 of the dual CP radiator 1300, respectively. In this example, the two conductors 1252 and 1254 have respective first and second metal walls 1262 and 1264 extending along the x-axis to narrow the beam along the y-axis. In the example shown in FIG. 16, the first and second metal walls 1262 and 1264 are disposed perpendicular to the stepped septum polarizer 1302, which separates the square CP waveguide radiator into the top input/output port 1304 and the bottom input/output port 1306. Alternatively, the two conductors 1252 and 1254 need not have transition angles of 90°, and the metal walls 1262 and 1264 of the two conductors 1252 and 1254 need not be parallel to the x-axis.

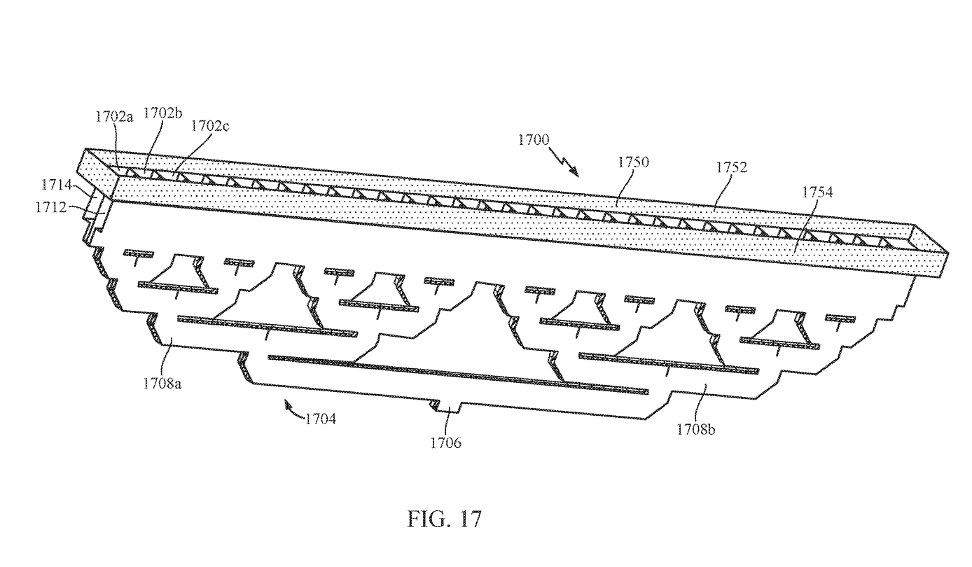

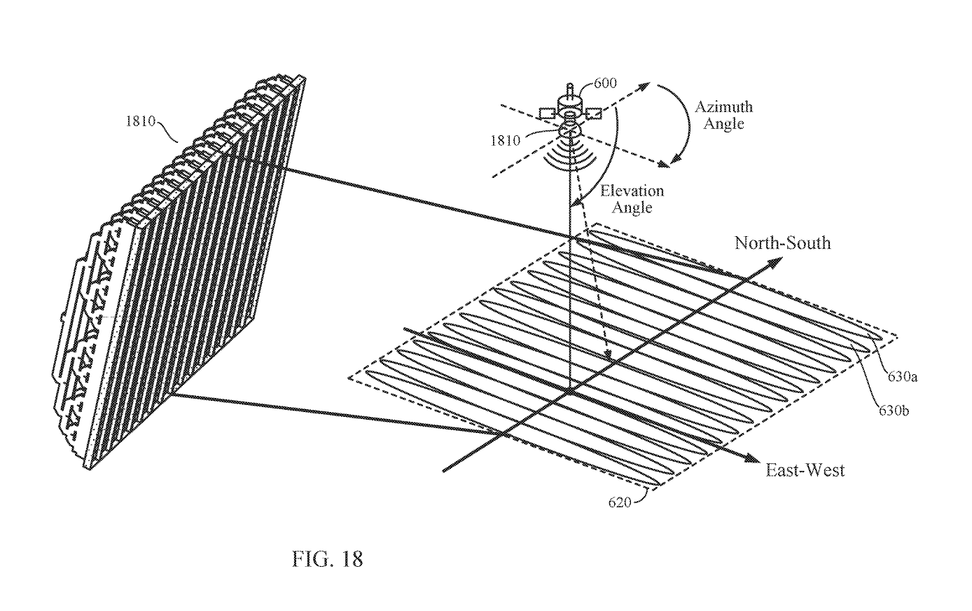

FIG. 17 is a perspective view of an alternate example of a satellite antenna 1700 with separate transmit and receive waveguide feeds. In FIG. 17, the satellite antenna 1700 includes a linear array of radiators 1702a, 1702b, 1702c, etc., coupled to a waveguide network 1704. In one aspect, the radiators 1702a, 1702b, 1702c, etc., may be similar to the radiators 1202a, 1202b, 1202c, etc., as described above with respect to FIG. 12. In one aspect, the structure of the waveguide network 1704 may have a similar tree structure to the waveguide network 1204 as described above with respect to FIG. 12, which includes multiple stages of 1:2 power splitters 1706, 1708a, 1708b, etc., in a similar pattern to the multiple stages of 1:2 power splitters for transmit RF signals as shown in FIG. 12 and described above. For receive RF signals, the 1:2 power splitters 1706, 1708a, 1708b, etc., function as 2:1 power combiners.

In contrast with the example shown in FIG. 12, the satellite antenna 1700 as shown in FIG. 17 includes transmit waveguide feeds 1712 separate from receive waveguide feeds 1714 in the waveguide network 1704. In one example, each of the radiators 1702a, 1702b, 1702c, etc., may have a dual CP radiator structure as shown in FIG. 13 and described above. In the example shown in FIG. 13, the dual CP radiator 1300 includes the stepped septum polarizer 1302 which separates the dual CP radiator 1300 into two input/output ports 1304 and 1306 with opposite circular polarizations. In one aspect, one of the input/output ports 1304 and 1306 may serve exclusively as a transmit port, whereas the other of the input/output ports 1304 and 1306 may serve exclusively as a receive port. Referring to FIG. 17, a conductive bracket 1750 similar to the bracket 1250 as shown in FIG. 12 and described above may be provided on the linear array of the radiators 1702a, 1702b, 1702c, etc., to limit the beamwidth in a given orientation. In FIG. 17, the conductive bracket 1750 includes conductors 1752 and 1754 similar to the two conductors 1252 and 1254 as shown in FIG. 12 and described above to produce a narrow beamwidth in an orientation perpendicular to the longitudinal orientation of the conductors 1752 and 1754.

In the above description, it is to be understood that where mention is made of circularly polarized radiation, the radiation may not exactly be circularly polarized, but may more generally be described as elliptically polarized. Accordingly, structures very similar to the above-described structures may employ elliptically polarized radiation. Accordingly, it is to be understood that circular polarization is a special case of elliptical polarization. Although in theory linearly polarized radiation may be considered a special case of elliptically polarized radiation, it is to be understood that in general linearly polarized radiation would not be employed for the satellite transmission and reception of signals from a UT.

According to various aspects, FIG. 18 is a diagram illustrating an example antenna array 1810 that may be used to form a composite beam pattern with multiple elliptical beams 630a, 630b, etc. having reconfigurable beamwidths to achieve a desired area or angular coverage 620. In particular, as described in further detail above with respect to FIG. 6, the multiple radio beams 630a, 630b, etc. are stacked in a North-South orientation to form a pattern in which the multiple radio beams 630a, 630b, etc. each have a relatively narrow beamwidth in the North-South orientation and a substantially wider beamwidth in the East-West orientation. Accordingly, to produce the composite beam pattern shown in FIG. 6 and FIG. 18 in which sixteen radio beams 630a, 630b, etc. are stacked in a mirror image, the antenna array 1810 includes sixteen linear radiator arrays that are each configured to generate a respective one of the sixteen radio beams 630a, 630b, etc. with a desired beamwidth in the North-South orientation and a substantially wider beamwidth in the East-West orientation. Furthermore, each radiator may have conductive walls disposed around an aperture associated therewith to narrow the wider beamwidths in the East-West orientation to a desired value associated with each respective radio beam 630a, 630b, etc. In various embodiments, the multiple radio beams 630a, 630b, etc. are each centered in the East-West direction and each individual radio beam 630a, 630b, etc. can be electrically or mechanically pointed to a certain angle in the North-South direction, thereby forming the composite beam pattern with the multiple radio beams 630a, 630b, etc. each having desired beamwidths.

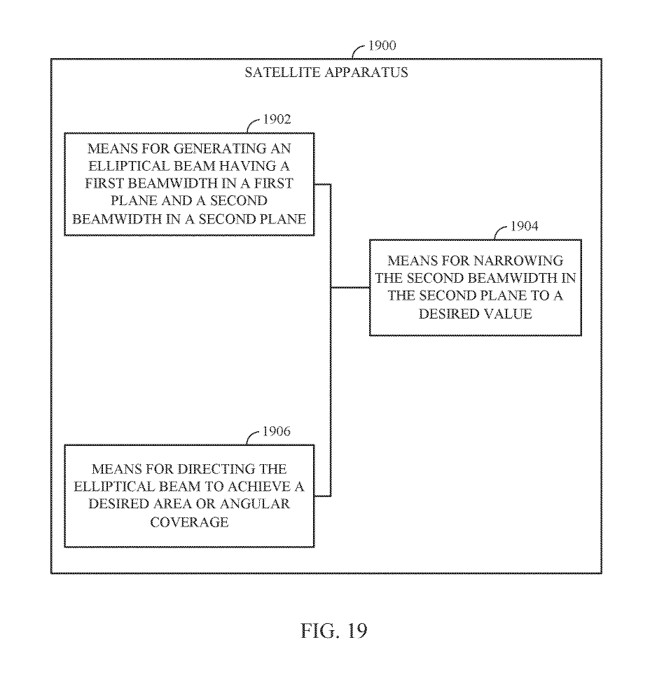

FIG. 19 illustrates an example satellite apparatus 1900 configured to generate an elliptical beam to achieve a desired area or angular coverage. The satellite apparatus 1900 may include means 1902 for generating an elliptical beam having a first beamwidth in a first plane and a second beamwidth in a second plane. For example, in various embodiments, the means 1902 may comprise a linear radiator array comprising N radiators that are configured to generate dual circularly polarized signals as discussed in further detail above. Furthermore, as described above with respect to FIG. 7-11, the means 1902 may be configured to generate the elliptical beam such that the first beamwidth in the first plane satisfies a design requirement while the second beamwidth in the second plane is wider than a design requirement. The satellite apparatus 1900 may therefore further include means 1904 for narrowing the second beamwidth in the second plane to a desired value. For example, in various embodiments, the means 1904 for narrowing the second beamwidth may comprise metal walls disposed around an aperture associated with each respective radiator in the linear radiator array, wherein the metal walls may include but are not limited to the various example shapes shown in FIG. 10A-10F. The satellite apparatus 1900 may further include means 1906 for directing the elliptical beam to achieve a desired area or angular coverage. For example, the means 1902 for generating the elliptical beam may be configured to center the elliptical beam in the first plane and the means 1906 may include mechanical or electrical means to point the elliptical beam at a particular angle in the second plane. Furthermore, in various embodiments, the means 1902, 1904, and 1906 may be provided in the satellite apparatus 1900 together with similar means to form a composite beam pattern comprising multiple elliptical beams that each provide a respective area or angular coverage. As such, those skilled in the art will appreciate that any of the various example design principles as described in further detail above may be used separately and/or in combination with one another to provide the various means 1902, 1904, 1906 in FIG. 19.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

While the foregoing disclosure shows illustrative aspects, it should be noted that various changes and modifications could be made herein without departing from the scope of the appended claims. The functions, steps, or actions of the method claims in accordance with aspects described herein need not be performed in any particular order unless expressly stated otherwise. Furthermore, although elements may be described or claimed in the singular, the plural is contemplated unless limitation to the singular is explicitly stated.

What is claimed is:

1. An antenna comprising:
a radio-frequency (RF) transmission network;
an array of radiators coupled to the RF transmission network, each radiator having a first port with a right-handed elliptical polarized radiation pattern and a second port with a left-handed elliptical polarized radiation pattern; and
a conductive bracket comprising at least a first conductive wall and a second conductive wall disposed along the array of radiators.

2. The antenna of claim 1, wherein the right-handed elliptical polarized radiation pattern is a right-handed circular polarized radiation pattern and the left-handed elliptical polarized radiation pattern is a left-handed circular polarized radiation pattern.

3. The antenna of claim 1, wherein each radiator comprises a linear-to-circular polarizer.

4. The antenna of claim 3, wherein each radiator further comprises a first feed port and a second feed port, and wherein the linear-to-circular polarizer for each radiator is configured to generate right-handed circular polarized radiation when transmitted or received by way of the first feed port to each radiator and to generate left-handed circular polarized radiation when transmitted or received by way of the second feed port to each radiator.

5. The antenna of claim 3, wherein the linear-to-circular polarizer for each radiator comprises a septum polarizer.

6. The antenna of claim 5, wherein the septum polarizer for each radiator comprises one or more of a stepped septum polarizer, a smooth-transitioned septum polarizer, or any combination thereof.

7. The antenna of claim 6, wherein the smooth-transitioned septum polarizer comprises one or more of an exponentially tapered septum polarizer, a linear polarizer, or any combination thereof.

8. The antenna of claim 5, wherein the septum polarizer for each radiator is disposed parallel with the first conductive wall and the second conductive wall.

9. The antenna of claim 5, wherein the septum polarizer for each radiator is disposed perpendicular to the first conductive wall and the second conductive wall.

10. The antenna of claim 1, wherein the first conductive wall and the second conductive wall each comprise a pair of conductors arranged at a ninety degree transition angle such that the first conductive wall and the second conductive wall each have an L-shape.

11. The antenna of claim 1, wherein the array of radiators is a linear array of radiators.

12. The antenna of claim 1, wherein the array of radiators is a two-dimensional array of radiators.

13. The antenna of claim 1, wherein the RF transmission network comprises a feed network.

14. The antenna of claim 13, wherein the feed network comprises one or more of a waveguide feed network, a stripline feed network, a microstripline feed network, or any combination thereof.

15. The antenna of claim 13, wherein the feed network comprises a plurality of power splitters/combiners.

16. The antenna of claim 15, wherein the plurality of power splitters/combiners comprises a plurality of 1:2 power splitters/combiners.

17. The antenna of claim 15, wherein the plurality of power splitters/combiners comprises a plurality of 1:M power splitters/combiners, where M is greater than two.

18. The antenna of claim 1, wherein each radiator comprises:
a first feed port;
a second feed port;
a linear-to-circular polarizer configured to generate right-handed circular polarized radiation when transmitted or received by way of the first feed port to each radiator and to generate left-handed circular polarized radiation when transmitted or received by way of the second feed port to each radiator; and
an impedance transformer between a feed network and one of the first feed port or the second feed port to each radiator.

19. The antenna of claim 1, wherein each radiator is an active radiator.

20. The antenna of claim 1, wherein each radiator comprises a transmit port, a receive port, a transmitter in the transmit port, and a receiver in the receive port.

21. The antenna of claim 20, wherein the transmit port and the receive port have opposite polarizations.

22. The antenna of claim 1, wherein each radiator comprises a first transceiver port, a second transceiver port, a first transceiver in the first transceiver port, and a second transceiver in the second transceiver port.

23. The antenna of claim 22, wherein the first transceiver port and the second transceiver port have opposite polarizations.

24. An apparatus comprising:
a waveguide network;
an array of radiators coupled to the waveguide network, the array of radiators aligned along a first direction and having a beam with a first beamwidth in the first direction, each radiator comprising a linear-to-circular polarizer; and
a conductive bracket aligned along the first direction to reflect radiation in a second direction orthogonal to the first direction.

25. The apparatus of claim 24, wherein the beam has a second beamwidth in the second direction orthogonal to the first direction, and wherein the second beamwidth in the second direction is larger than the first beamwidth in the first direction.

26. The apparatus of claim 25, wherein the first beamwidth in the first direction is controlled according to a number of radiators in the array of radiators and an inter-element spacing between the radiators in the in the array of radiators, and wherein the conductive bracket is configured to shape the second beamwidth in the second direction.

27. The apparatus of claim 24, wherein each radiator comprises:
a first feed port coupled to the waveguide network; and
a second feed port coupled to the waveguide network, wherein the linear-to-circular polarizer for each radiator is configured such that the beam has a right-handed circular polarization corresponding to a first signal communicated via the first feed port and a left-handed circular polarization corresponding to a second signal communicated via the second feed port.

28. The apparatus of claim 24, wherein the linear-to-circular polarizer for each radiator comprises a septum polarizer.

29. The apparatus of claim 28, wherein the septum polarizer for each radiator comprises one or more of a stepped septum polarizer, a smooth-transitioned septum polarizer, or any combination thereof.

30. The apparatus of claim 29, wherein the smooth-transitioned septum polarizer comprises one or more of an exponentially tapered septum polarizer, a linear polarizer, or any combination thereof.

31. The apparatus of claim 24, wherein:
each radiator comprises a first port having a right-handed circular polarization radiation pattern and a second port having a left-handed circular polarization radiation pattern, and
the conductive bracket comprises a plurality of conductive walls, the plurality of conductive walls comprising a first conductive wall proximal to the first port and a second conductive wall proximal to the second port.

32. The apparatus of claim 31, wherein the first conductive wall and the second conductive wall each comprise a pair of conductors arranged at a ninety degree transition angle such that the first conductive wall and the second conductive wall each have an L-shape.

33. The apparatus of claim 31, wherein the linear-to-circular polarizer for each radiator comprises a septum polarizer disposed in parallel with the conductive walls.

34. The apparatus of claim 31, wherein the linear-to-circular polarizer for each radiator comprises a septum polarizer disposed perpendicular to the conductive walls.

35. An apparatus comprising:
an array of radiators aligned along a first direction and having a beam with a first beamwidth in the first direction, each radiator comprising means for generating dual circularly polarized signals; and
means for reflecting radiation associated with the dual circularly polarized signals, the means for reflecting radiation aligned along the first direction and configured to reflect the radiation in a second direction orthogonal to the first direction.

36. The apparatus of claim 35, wherein the beam has a second beamwidth in the second direction orthogonal to the first direction, and wherein the second beamwidth in the second direction is larger than the first beamwidth in the first direction.

37. The apparatus of claim 36, wherein the first beamwidth in the first direction is controlled according to a number of radiators in the array of radiators and an inter-element spacing between the radiators in the in the array of radiators, and wherein the means for reflecting radiation is further configured to shape the second beamwidth in the second direction.

38. The apparatus of claim 35, wherein the dual circularly polarized signals comprise:
a first signal having a right-handed circular polarization, and
a second signal having a left-handed circular polarization.

39. The apparatus of claim 35, wherein the means for generating the dual circularly polarized signals comprises a septum polarizer.

40. The apparatus of claim 39, wherein the septum polarizer comprises one or more of a stepped septum polarizer, a smooth-transitioned septum polarizer, or any combination thereof.

41. The apparatus of claim 40, wherein the smooth-transitioned septum polarizer comprises one or more of an exponentially tapered septum polarizer, a linear polarizer, or any combination thereof.

42. The apparatus of claim 35, wherein the means for reflecting radiation comprises a plurality of conductive walls.

43. The apparatus of claim 42, wherein the plurality of conductive walls each comprise a pair of conductors arranged at a ninety degree transition angle such that the plurality of conductive walls each have an L-shape.

44. The apparatus of claim 42, wherein the means for generating the dual circularly polarized signals comprises a septum polarizer disposed in parallel with the conductive walls.

45. The apparatus of claim 42, wherein the means for generating the dual circularly polarized signals comprises a septum polarizer disposed perpendicular to the conductive walls.

46. A method for forming an antenna structure, comprising:
forming a linear array of radiators along a first plane, the linear array of radiators configured to generate an elliptical beam having a first beamwidth in the first plane; and
forming a conductive bracket around each radiator in the linear array of radiators, the conductive bracket configured to reflect radiation such that the elliptical beam has a second beamwidth in a second plane orthogonal to the first plane.

47. The method of claim 46, wherein the first beamwidth and a desired operating frequency for the antenna structure define a minimum height (H) for the linear array of radiators.

48. The method of claim 46, wherein forming the linear array of radiators further comprises forming each radiator in the linear array of radiators such that each radiator has a width (W) based on a minimum operating frequency for the antenna structure.

49. The method of claim 48, wherein forming the linear array of radiators further comprises providing an inter-element spacing (d) between adjacent radiators in the linear array of radiators, the inter-element spacing (d) constrained to be within a range that has a lower bound based on the radiator width (W) and an upper bound based on a maximum operating frequency for the antenna structure.

50. The method of claim 49, wherein the linear array of radiators comprises N radiators, where N is an integer value based on a minimum height (H) to obtain the first beamwidth at a desired operating frequency in combination with the inter-element spacing (d) between the adjacent radiators in the linear array of radiators.

51. The method of claim 46, wherein forming the conductive bracket comprises coupling a first conductive wall and a second conductive wall to opposing sidewalls of each radiator such that the first conductive wall, the second conductive wall, and each radiator have a combined width (W₂) to narrow the second beamwidth in the second plane to a desired value.

52. The method of claim 51, wherein the first conductive wall and the second conductive wall are coupled to the opposing sidewalls of each radiator at a distance (S) behind an aperture of each radiator, the distance (S) based at least in part on a wavelength at a desired operating frequency for the antenna structure.

53. The method of claim 52, wherein the conductive bracket is formed to extend outwardly from the aperture of each radiator such that the conductive bracket has a length (T) that depends on the distance (S) in combination with the desired operating frequency for the antenna structure.

54. A method for configuring an antenna beam footprint, comprising:
generating, via a linear radiator array, an elliptical beam with a first beamwidth in a first plane and a second beamwidth in a second plane; and
reflecting radiation by a conductive bracket aligned along the first plane such that the second beamwidth in the second plane is shaped to a desired value.
